(19) United States
(12) Patent Application Publication
(10) Pub. No.: US 2026/0050331 A1
(43) Pub. Date: Feb. 19, 2026

(54) ANTENNAS AS SENSORS (A2S) AND MICROPHONE SIGNALS FOR EVENT DETECTION

(71) Applicant: Amazon Technologies, Inc., Seattle, WA (US)

(72) Inventors: Steven Sensarn, Milpitas, CA (US); Jason Wang, Belmont, CA (US); Nicholas Evangelos Buris, Chicago, IL (US)

(21) Appl. No.: 18/808,226

(22) Filed: Aug. 19, 2024

(51) Int. Cl. G06F 3/01; G01S 13/04; G06F 3/16

(52) U.S. Cl. CPC G06F 3/017; G01S 13/04; G06F 3/165

(57) ABSTRACT

Technologies directed to providing event detection using Antennas as Sensors (A2S) and microphone signals are described. One method of operating a device includes receiving audio data corresponding to audio captured by at least one microphone of the device, and impedance data from an Antenna as Sensor (A2S) system of the device, the impedance data is digital data representing impedance changes of an antenna captured by the A2S system. The method determines, using the audio data and the impedance data and a machine learning (ML) model, a user input event representing a physical interaction event with the device. The method performs an action in response to the user input event.

### BACKGROUND

A large and growing population of users is enjoying entertainment through the consumption of digital media items, such as music, movies, images, electronic books, and so on. The users employ various electronic devices to consume such media items. Among these electronic devices (referred to herein as endpoint devices, user devices, clients, client devices, or user equipment) are electronic book readers, cellular telephones, Personal Digital Assistants (PDAs), portable media players, tablet computers, netbooks, laptops, and the like. These electronic devices wirelessly communicate with a communications infrastructure to enable the consumption of digital media items. In order to communicate with other devices wirelessly, these electronic devices include one or more antennas. The devices often provide for touch-based user interactions to control the functionality of the device (e.g., playback functionality, volume control, etc.) With the advancement of technology, the use and popularity of electronic devices has increased considerably. Electronic devices are commonly used to capture and process audio data.

### BRIEF DESCRIPTION OF DRAWINGS

The present inventions will be understood more fully from the detailed description given below and from the accompanying drawings of various embodiments of the present invention, which, however, should not be taken to limit the present invention to the specific embodiments, but are for explanation and understanding only.

FIG. 1 is a block diagram of a wireless device with an antenna, tap classification logic, and detection circuit to detect a touch event or a gesture event caused by a physical interaction with the wireless device according to at least one embodiment.

FIG. 2 is a schematic diagram of a detection circuit that detects and converts an amount of reflected power in a radio frequency (RF) path to a voltage waveform according to at least one embodiment.

FIG. 3 is a graph illustrating an output signal of a detection circuit during normal communication transmissions of a radio according to at least one embodiment.

FIG. 4 illustrates graphs of a voltage response in free space and in the presence of a object using a remote antenna and a graph of a reflection signal response in free space in the presence of a object using the remote antenna according to at least one embodiment.

FIG. 5 illustrates graphs of antenna impedance change, return loss, and detector circuit output signals according to at least one embodiment.

FIG. 6 is a graph showing ADC steps for different use cases according to at least one embodiment.

FIG. 7 illustrates a block diagram of a system with tap classification logic configured to perform multi-branched sensor fusion and event detection according to at least one embodiment.

FIG. 8 is a graph showing raw Antennas as Sensors (A2S) signal, as measured by the analog-to-digital converter (ADC), from three sequential transmissions of a BLE advertisement packet over three Bluetooth channels according to at least one embodiment.

FIG. 9 illustrates a first graph of an unfiltered three-channel A2S signal and a second graph of a filtered three-channel A2S signal according to at least one embodiment.

FIG. 10 is a graph showing a preprocessed A2S signal according to at least one embodiment.

FIG. 11 is a flow diagram of high-level algorithm logic of tap classification logic according to at least one embodiment.

FIG. 12A is a graph illustrating a preprocessed A2S signal for fifty taps, according to at least one embodiment.

FIG. 12B is a graph illustrating a preprocessed audio signal for the same fifty taps, according to at least one embodiment.

FIG. 12C is a graph illustrating a raw accelerometer signal along with tap and non-tap predictions for the accelerometer and audio fusion algorithm according to at least one implementation.

FIG. 12D is a graph illustrating Inter-channel Level Difference (ILD) feature data for the accelerometer and audio fusion algorithm according to at least one implementation.

FIG. 13A is a graph illustrating a preprocessed A2S signal for non-tap activity, according to at least one embodiment.

FIG. 13B is a graph illustrating a preprocessed audio signal for the same non-tap activity, according to at least one embodiment.

FIG. 14 illustrates multiple gestures and corresponding actions according to at least one embodiment.

FIG. 15 illustrates examples of tap detection decisions according to embodiments of the present disclosure

FIG. 16 show a few examples of ergonomically suitable areas for placement of an antenna according to various embodiment.

FIG. 17 illustrates an example component diagrams for a tap detection pipeline according to at least one embodiment.

FIG. 18 illustrates an example component diagrams for an event detection pipeline according to at least one embodiment.

FIG. 19A to FIG. 19B illustrate examples of performing tap detection during alarm notifications according to embodiments of the present disclosure.

FIG. 20 is a flow chart of a method of detecting a physical interaction event according to at least one embodiment.

FIG. 21 is a block diagram of a wireless device with tap classification logic and a detection circuit according to one embodiment.

### DETAILED DESCRIPTION

Technologies directed to providing event detection using Antennas as Sensors (A2S) and microphone signals are described. These technologies provide tap/touch recognition in devices with wireless transceivers and microphones by using the antenna, the microphones, and a detection algorithm, including machine learning detection methods. These technologies provide recognition of physical interactions with a device by a user. Touching a consumer device, such as smart speakers, earbuds, etc., in a certain way can be used as one type of user input as a user interface. A tap, double tap, long tap, swipe, or other physical interactions can be interpreted as user commands and set or modify the device settings according to a certain pre-agreed etiquette.

Conventional consumer devices, such as earbuds and smart speaker devices, use buttons, accelerometers, or a dedicated “touch” integrated circuit (IC) to detect the touch by a user's finger. The touch IC often uses two or more “touch electrodes” and monitors the capacitance between different pairs as they are excited by the touch IC. The excitation is typically at a low frequency (e.g., 250 kHz), and it occurs in parallel to all other functions of the earbud. Touch detection with only accelerometers suffers from “false positives” when vibrations in the environment, e.g., furniture on which a device is placed, accidentally trigger a response. Accelerometers typically require that the device be “physically” touched.

These consumer devices typically already include an antenna system to wirelessly send or receive radio transmissions to and from another device. However, users are demanding products with increasingly smaller form factors. The limited form factor can result in constraints on the physical volume and positioning of the touch electrodes (or physical buttons) and one or more antennas that are used to wirelessly send or receive radio transmissions to and from another device. The Bluetooth® wireless technology has been widely adopted across the consumer industry in many consumer products, including smart phones, smart wearable devices, wireless speakers, wireless earbuds, remote controls, etc. These devices often require a means to control the device, such as a touch sensing controller that enables a user to control operations of the device, such as playback, volume, power, or the like. To cater to the natural behavior of the user to touch the device, it is desirable to have a touch sensor at a specific location on the device. The demand for dedicated user-interactive features (such as touch-enabled features) uses real estate within these device. Antennas also use real estate within these devices. For conventional wireless devices with touch capability use two separate integrated circuits, one integrated circuit for antenna operations and another for touch sensing operations.

Some electronic devices may be used to capture and process audio data. The audio data may be used for voice commands and/or may be output by loudspeakers as part of a communication session. In some examples, loudspeakers may generate audio using playback audio data while a microphone generates local audio data. While the device may process the audio data to identify a voice command and perform a corresponding action, processing the voice command may require complex processing and/or a delay while the audio data is sent to a remote system for speech processing.

Aspects and embodiments of the present disclosure overcome these deficiencies and others by providing tap classification logic that processes A2S signals from an A2S system and audio signals from one or more microphones to classify tap or touch events of a device. The device uses an antenna for both radio frequency (RF) communications and as a sensor for touch sensing, referred to herein as Antennas as Sensors (A2S) technology. A2S signals (also referred to herein as impedance data) represent changes in impedance of the antenna. The A2S signals and microphone signals can be preprocessed and combined into a neural network classifier trained to predict whether a given excitation constitutes a tap gesture or a “non-tap” (any action that is not an intentional tap on the surface of the device (e.g., smart speaker) by a user). Some neural network-based tap classifiers can combine accelerometer and microphone signals to predict tap gestures using accelerometer and microphone data fusion algorithms. In those implementations, the accelerometer data is fed as-is into the neural network, while audio data is preprocessed into audio features, such as Inter-channel Level Difference (ILD) or root-mean-square (RMS) amplitude). Aspects and embodiments of the present disclosure can use the new sensing modality of A2S, in place of the accelerometer. Aspects and embodiments of the present disclosure can use preprocessing techniques that lead to improvements in performance over the accelerometer and microphone data fusion algorithms.

In general, a sensor is a circuit that detects and converts a physical phenomenon like temperature, pressure, or the like into a resistance change, which is converted into a measurable quantity that can quantify the impact of the physical phenomenon. Aspects and embodiments of the present disclosure use the A2S technology by measuring reflected power in an RF path caused by an antenna impedance change from a presence of an object in proximity to the antenna. For example, a finger touch, a palm touch, or a palm hovering around the antenna can be detected and distinguished from one another and interpreted as user commands, such as pause or resume music, change a track, turn on a light, turn off a light, or the like. Touching a wireless device, such as a smart speaker or an earbud, in a certain way can be used as another user interface for interacting with the wireless device. Touch or hover events, such as a tap, a double tap, a long tap, a swipe, a tap and hold, a palm tap, a palm and hold, or the like, either touching or in close proximity to the antenna, can be interpreted as user commands. The user commands can set or modify the device settings according to specified configurations or operations. Aspects and embodiments of the present disclosure set forth apparatuses and methods for event detection by utilizing the existing radio transmissions of the wireless devices and microphone signals.

Aspects and embodiments of the present disclosure can improve user interfaces by detecting when a physical interaction event, such as a tap event or other events/activity, occurs on a surface of a device using a multi-branched network for sensor fusion. For example, instead of using a physical sensor to detect the tap event, a device may detect a tap event using a combination of microphone audio data and the A2S data, representing changes in impedance of the antenna. Prior to combining these inputs for further inference, the device may use separate neural networks to independently extract features from the audio data and the A2S data. This multi-branch approach improves an accuracy of tap detection and enables detection of additional tap gestures and/or other types of event/activity detection. It should be noted that for the detection of unpredictable human gestures, ML, Neural Networks, etc. may be the most suitable detection algorithms. However, in other use cases, where the “gestures” are more deterministic (e.g. an object approaching an A2S+MIC enabled device in a factory setting, or in a Machine-to-Machine interaction), detection algorithms based on some sort of convoluted but deterministic logic, may be more appropriate.

In some examples, the multi-branched network may generate fused data by preprocessing audio data (or audio features) and A2S data (or A2S features). In other examples, the multi-branched network may generate the fused data by processing raw audio data, raw A2S data, and/or additional sensor data. Depending on the inputs, a number of branches, a branch depth, and/or a number of event detectors may vary without departing from the disclosure. The device may process the fused data to detect a tap event and perform an action. For example, the device may interpret a detected tap event as an input to delay or end an alarm, turn a light switch on or off, turn music on or off, and/or the like, although the disclosure is not limited thereto. In some examples, the device may process the fused data using two or more event/activity detectors, enabling the device to detect multiple tap events, gestures, typing events, and/or the like based on a common input. In addition to single touch or tap events or gestures, aspects and embodiments of the present disclosure can use a single antenna, a detection circuit, and tap classification logic to distinguish between multiple touch buttons and directional swipe gestures to provide more advanced touch and gesture detection in these devices.

Aspects and embodiments of the present disclosure use the normal wireless transmissions of the wireless device and, instead of dedicated electrodes, use the antenna and microphone as the sensing modalities. Aspects and embodiments of the present disclosure can provide a better user experience than dedicated buttons and accelerometer-based designs.

In at least one embodiment, a wireless device can include a processing device with an analog-to-digital converter (ADC) and tap classification logic and a detection circuit located in an RF path between a radio and an antenna. The antenna can be used to send or receive RF signals to or from the radio and radiate or receive electromagnetic energy to or from another wireless device. The detection circuit is coupled between the radio and the antenna. The detection circuit can output an analog voltage signal to the ADC, the analog voltage signal representing characteristics of the impedance of the antenna. The analog voltage signal can be based on (i.e., as a function of) an impedance value of the antenna. The ADC can sample the analog voltage signal at the plurality of frequencies over a period of time to obtain digital data. In particular, the ADC can sample the analog voltage signal at the plurality of frequencies at a first time to obtain first digital data and at a second time to obtain second digital data. The tap classification logic can use the digital data and the audio data to classify one or more physical interactions with the device over the period of time as a touch event or a gesture event. In particular, the tap classification logic can determine, using the first digital data and first audio data from a first microphone, that a presence of an object in proximity to the antenna is located at a first position of the device. The tap classification logic can determine, using the second digital data and second audio data from a second microphone, that the presence of the object in proximity to the antenna is located at a second position of the device. The tap classification logic can determine a gesture event using the first position and the second position. The processing device can perform an action in response to the touch event or gesture event. In addition to the ability to discern two points from the location of two microphones, as described herein, the processing device can discern between two points by the location of two antennas, assuming both antennas are A2S enabled. Similarly, unique antenna designs of a single antenna can be used to distinguish between a few different points.

In at least one embodiment, the classification logic can implement a dedicated classification algorithm (e.g., pre-loaded in a System on Chip (SoC)) that classifies the physical interactions events and maps them to different actions/commands for the device according to a pre-agreed etiquette.

In various embodiments described herein, the radio transmits signals which, although part of the radio's wireless protocol, have no intention to communicate with another radio. For example, the radio can transmit BLE non-connectable transmissions. These transmissions can be used for sensing purposes alone. These transmissions can occur over and above the normal communication transmissions of the radio to another wireless device. In other embodiments, any regular communication transmissions can be used for sensing purposes. So, sensing specific transmissions as well as re-using/re-purposing normal communication transmissions can be used for sensing purpose (i.e. sensing and communicating simultaneously).

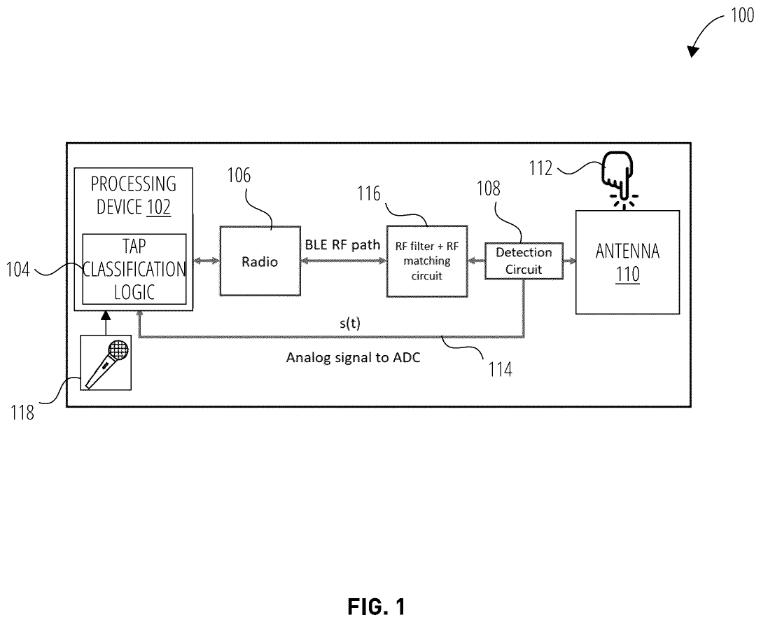

FIG. 1 is a block diagram of a wireless device 100 with an antenna 110, tap classification logic 104, and detection circuit to detect a touch event or a gesture event caused by a physical interaction with the wireless device 100 according to at least one embodiment. The wireless device 100 includes a processing device 102 that includes an analog-to-digital converter (ADC) and tap classification logic 104. In at least one embodiment, the processing device 102 is a SoC that manages, among other things, the wireless protocol of a radio 106 (e.g., wireless communication component) coupled to the processing device 102 and other aspects of the behavior and operation of the wireless device 100. The processing device 102 can control operations of the radio 106 to communicate with one or more devices over one or more communication links. The radio 106 can implement the Wi-Fi® technology, the Bluetooth® technology, or both. Alternatively, the radio 106 can implement other radio technologies. The processing device 102 is coupled to the detection circuit 108, which is coupled between the radio 106 and the antenna 110. One or more microphones 118 are coupled to the processing device 102. The one or more microphones 118 generates audio data, as described in more detail herein.

As described in more detail herein, the characteristics of the antenna 110 change when a user performs a gesture such as tap/touch/swipe/hover in close proximity to the antenna 110. Any such gesture is a time varying event. It should be noted that tap and touch pertain to contacting the device by hand at a single point. Taps are quick and could be “strong” while “touches” are softer (i.e. less forceful). A swipe is a trajectory of the hand/finger while maintaining contact with the surface of the device. A “hover” is like a tap or a touch without actually making contact with the device. Finally, the term “directional hovering” is used for a swipe that does not make contact with the device. The detection circuit 108, which is inserted in the RF path, can translate the antenna's instantaneous characteristics into a time varying output signal 114, defined as s(t), which is guided to, and read by the tap classification logic 104. As described herein, an event detection method relies on variations of the antenna impedance (i.e., differences between being touched and not being touched). The event detection method can apply regardless of the variability from user to user, or variability from device to device. The level of the output signal 114, s(t), from the detection circuit 108 can be adjusted by the appropriate choice of its constituent components. The present embodiments are focused on enabling the functionality of multiple touch buttons simultaneously, as well as complicated gestures detection, such as directional swipes, with a single antenna or multiple antennas.

The detection circuit 108 can measure an amount of reflection signals, in an RF path between the radio 106 and the antenna 110, caused by changes in the impedance of the antenna 110. The detection circuit 108 can provide an output signal 114, s(t), to the processing device 102. The output signal 114 can be an analog voltage output signal (also referred to herein as voltage waveform, analog voltage signal, or the like) that is affected by the amount of reflection signals. The changes in impedance can be caused by the presence of an object 112 in proximity to the antenna 110. The wireless device 100 can include an ADC channel that can sample the output signal 114. The ADC can sample the output signal 114 at one or more multiple frequencies for the tap classification logic 104. The tap classification logic 104 can use the samples and audio data to determine a physical interaction with the wireless device 100 that cause the wireless device 100 to perform one or more actions.

In at least one embodiment, the detection circuit 108 is inserted just in front of the antenna 110 in an RF path between the radio 106 and the antenna 110. The detection circuit 108 can provide the analog voltage output signal 114, s(t), which is guided to, and read by the processing device 102 via one of its embedded ADC channels. The characteristics of the antenna 110 change when it is approached by an object, such as a finger or palm of a user. Concomitantly, the output signal 114 of the detection circuit 108 changes. The tap classification logic 104 in the processing device 102 monitors the temporal changes in the output signal 114, s(t), and interprets the temporal changes as user commands based on a predetermined etiquette. In at least one embodiment, the RF path also includes RF filtering and matching circuitry 116 coupled between the radio 106 and the detection circuit 108. The RF filtering and matching circuitry 116 can perform RF filtering of the RF signals and provide impedance matching between the radio 106 and the antenna 110. The presence of the detection circuit 108 in the RF path does not significantly impact the radio operations of the radio 106.

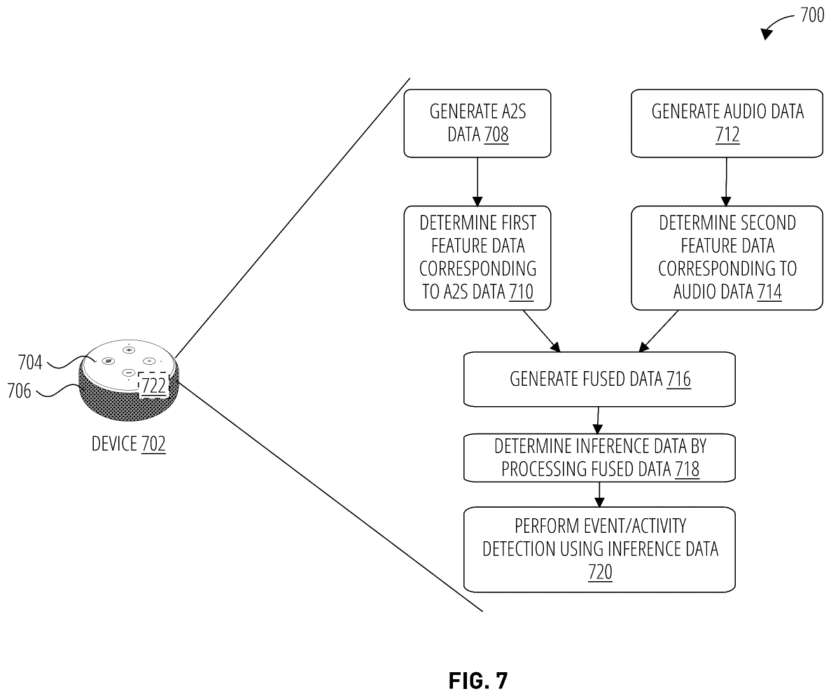

In at least one embodiment, the wireless device 100 is a smart speaker device (e.g., the Amazon Echo device), such as illustrated in FIG. 7. The smart speaker device can be configured to wirelessly communicate radio signals to and from another device. The smart speaker device includes a housing and a circuit board that is disposed within the housing. The antenna can be printed or disposed on a non-cosmetic surface (e.g., the top inside surface of the housing). This decreases the cost of the smart speaker device by shifting the design to the non-cosmetic surface of the housing, thereby eliminating the need for secondary manufacturing processes. The antenna can be printed or disposed on a cosmetic surface as well. Instead of including separate touch circuitry coupled to the antenna 110, the detection circuit 108 is coupled between the radio 106 and the antenna 110. In other embodiments, the antenna 110 can be deployed as a substitute for any mechanical or electrical button used in a device. For example, the antenna 110 can be used to turn lights on and off, turn a device on and off, change a state of the device based on the user interaction, or the like.

In at least one embodiment, the wireless device 100 is a wireless earbud (or simply an earbud). The wireless earbud can be configured to wirelessly communicate radio signals to and from an audio source for processing and playback by one or more speaker components of the wireless earbud. The wireless earbud includes a housing and a circuit board that is disposed within the housing. The antenna architecture of the wireless earbud can be printed or disposed on a non-cosmetic surface (e.g., the top inside surface of the housing) of the wireless earbud. At least some portion of a metal element serves effectively as a zero-footprint antenna. A zero-footprint antenna means there is no dedicated ground clearance on the circuit board dedicated to the antenna. This enables a highly miniaturized product. Instead of including separate touch circuitry coupled to the antenna 110, the detection circuit 108 is coupled between the radio 106 and the antenna 110. The wireless earbud can include an audio output device, such as an audio speaker, to produce/playback audio, such as voice calls, media, etc. In other embodiments, the antenna 110, the tap classification logic 104, and the detection circuit 108 can be deployed as a substitute for any mechanical or electrical button used in a device to turn lights on and off, turn a device on and off, change a state of the device based on the user interaction, or the like.

In at least one embodiment, the radio 106 is disposed on the circuit board and is coupled to an antenna feed (RF input or RF feed point). The radio 106 can drive the antenna 110 using one or more RF signals in an RF path. A current flow on the RF path can induce current on the antenna 110 to cause the antenna 110 to radiate electromagnetic energy. The radio 106 can also receive RF signals, received as electromagnetic energy by the antenna 110. The antenna 110 can be a monopole, a loop, a patch, a slot, or the like. The radio 106 can cause the antenna 110 to radiate and receive electromagnetic energy in a specified frequency range, such as the 2.4 GHz frequency band for wireless personal area network (WPAN) applications (e.g., Bluetooth® Classic or Bluetooth® Low Energy (BLE) technology), wireless local area network (WLAN) applications (e.g., Wi-Fi® technology), or the like. In one embodiment, an operating frequency of the radio 106 is a wide area network (WAN) frequency band (e.g., 5G, Long Term Evolution (LTE) technology, or the like).

In at least one embodiment, during the operation of the wireless device 100, the radio sends an RF signal to the antenna 110 via a first path (primary RF path) to radiate electromagnetic energy. The detection circuit 108 is located in a second path (also referred to herein as a shunt load, a trapped path, or a coupled path). The detection circuit 108 can detect and convert an amount of reflected power in the first path to a voltage waveform. The amount of reflected power is also referred to as “coupled power.” The amount of reflected power in the first path varies in response to changes in impedance of the antenna 110. The ADC of the processing device 102 can convert the voltage waveform into digital data. The tap classification logic 104 uses the digital data to detect a change in impedance that satisfies a first criterion representing a possible touch event or a possible hover event caused by a presence of an object 112 in proximity to the antenna 110. For example, the change in impedance can exceed a first threshold. The tap classification logic 104 can detect that amplitudes of the audio data satisfies a second criterion representing a possible touch event or a possible hover event caused by a presence of an object 112 in proximity to the antenna 110. The tap classification logic 104 can also use the digital data, sampled at multiple frequencies, to classify one or touches over a period of time as a gesture event (or a touch event). The gesture event can be a directional swipe gesture, a multi-directional swipe gesture, or the like.

In at least one embodiment, the processing device 102 can perform an action in response to the touch event or the hover event. In at least one embodiment, the action is at least one of starting an audio file, stopping an audio file, pausing playback of the audio file, resuming playback of the audio file, changing playback of a subsequent audio file in a list or a previous audio file in the list, increasing a volume, or decreasing the volume.

In at least one embodiment, the tap classification logic 104 is firmware executed by the processing device 102. The firmware can use the ADC readings and the audio data to detect different use cases described herein. In at least one embodiment, the tap classification logic 104 is a hardware, such as a state machine of the processing device 102. In at least one embodiment, the tap classification logic 104 is combination logic. In at least one embodiment, the tap classification logic 104 is a detection algorithm. The detection algorithm can be implemented using processing logic comprising hardware, software, firmware, or any combination thereof.

In at least one embodiment, the antenna 110 of the radio 106 is made to communicate with other radios at relatively far distances. So, they are typically placed at such a location on a device so that they can radiate efficiently and be manufacturable at an appropriate cost. The antenna 110 can also be placed at a location so as to also provide an ergonomically convenient user interface for the purpose of gesture detection. In some embodiments, if only simple gestures, such as touch or mere proximity (e.g., hovering over), are sought, any existing antenna could work, with minimal modifications, if any, provided the antenna 110 is placed at the desired location for the detection of the touch/hover events. In other embodiments, specific antenna designs can enable more complicated gestures, such as swipes. Yet, other antenna designs enable the detection of gestures at several, distinguishable points.

In at least one embodiment, the wireless device 100 can detect changes in impedance to detect a touch event, a hover event, or a gesture event, caused by an object 112 (e.g., object) in proximity to the antenna 110. The wireless device 100 can include RF front-end circuitry, including the RF filtering and matching circuitry 116 and the detection circuit 108. The detection circuit 108 can measure an amount of reflection signals in the RF front-end circuitry. The variations in reflection signals can be caused by changes in the impedance of the antenna 110. The detection circuit 108 can provide an analog signal (output signal 114) to the processing device 102. The analog signal can be an analog voltage output signal that represents the amount of reflection signals. The changes in impedance can be caused by the presence of an object in proximity to the antenna 110. The processing device 102 can include an ADC that can sample the analog signal to obtain digital data or samples of amplitude or gain values of the analog signal at a specified frequency. The processing device 102 can sample the output signal 114 at one or more multiple frequencies for the tap classification logic 104. The tap classification logic 104 can use the samples and audio data to determine a physical interaction with the wireless device 100 that cause the wireless device 100 to perform one or more actions.

In at least one embodiment, the processing device 102 cause the radio 106 to send, at a first time, a first RF signal to the antenna 110 to radiate electromagnetic energy at a first frequency. At the first time, the processing device 102 can measure a first voltage based on a first impedance value of the antenna 414 using the detection circuit 108 and the first RF signal. At a second time, the processing device 102 cause the radio 106 to send a second RF signal to the antenna 110 to radiate electromagnetic energy at a second frequency. At the second time, the processing device 102 measures a second voltage based on a second impedance value of the antenna 110 using the detection circuit 108 and the second RF signal. The processing device 102 can determine, using at least the first voltage and the second voltage, a change in impedance that satisfies a criterion representing a touch event or a hover event caused by an object in proximity to the antenna 110. The processing device 102 performs an action in response to the touch event or the hover event. The action can be any one of the following actions: starting an audio file; stopping an audio file; pausing playback of the audio file; resuming playback of the audio file; changing playback of a subsequent audio file in a list or a previous audio file in the list; increasing a volume; decreasing the volume, or the like. In at least one embodiment, the touch event is at least one of a tap, a double tap, a tap and hold, a swipe, a palm tap and hold, or the like. In other embodiments, some or all of these operations are performed by the tap classification logic 104.

In at least one embodiment, the processing device 102 cause the radio 106 to send, at a first time, a first RF signal to the antenna 110 to radiate electromagnetic energy at a first frequency. At the first time, the processing device 102 can measure a first voltage based on a first impedance value of the antenna 414 using the detection circuit 108 and the first RF signal. The processing device 102 can sample the first voltage at a set of frequencies. At a second time, the processing device 102 cause the radio 106 to send a second RF signal to the antenna 110 to radiate electromagnetic energy at a second frequency. At the second time, the processing device 102 measures a second voltage based on a second impedance value of the antenna 110 using the detection circuit 108 and the second RF signal. The processing device 102 can sample the second voltage at the set of frequencies. The processing device 102 can determine a touch point from the sampled first voltage and a second touch point from the sampled second voltage. The processing device can determine, from the first and second touch points, a touch event or a gesture event caused by an object in proximity to the antenna 110. The processing device 102 performs an action in response to the touch event or the gesture event. The action can be any one of the following actions: starting an audio file; stopping an audio file; pausing playback of the audio file; resuming playback of the audio file; changing playback of a subsequent audio file in a list or a previous audio file in the list; increasing a volume; decreasing the volume, or the like. In at least one embodiment, the touch event is at least one of a tap, a double tap, a tap and hold, a swipe, a palm tap and hold, or the like. In other embodiments, some or all of these operations are performed by the tap classification logic 104.

In at least one embodiment, the radio 106 sends the first RF signal in an advertising channel of a wireless personal area network (WPAN) protocol. In at least one embodiment, the first RF signal is included in an advertising channel of the Bluetooth Low Energy (BLE) standard. In at least one embodiment, the radio 106 sends the first RF signal in a first advertising channel of the WPAN protocol and the second RF signal in a second advertising channel of the WPAN protocol. In at least one embodiment, the first RF signal is included in a first advertising channel of the BLE standard, and the second RF signal is included in a second advertising channel of the BLE standard. It should be noted that technologies described herein could be applied to many transmitting radios. A BLE radio is a low-cost solution amongst the typical radios deployed in wireless devices. It should also be noted that the technologies described herein are directed to touch and gesture recognition while transmitting data on the antenna 110. In some cases, different features could be used to accommodate touch and gesture recognition while receiving data on the antenna 110.

In at least one embodiment, the detection circuit 108 measures the first voltage by detecting an amount of reflection coefficient of the antenna 110 (i.e., reflected power in the first path). The detection circuit 108 can convert the amount of reflected power to a voltage waveform. The amount of reflected power in the first path varies in response to changes in impedance of the antenna 110. The processing device 102 can convert, using the ADC, the voltage waveform into digital data. In at least one embodiment, the detection circuit 108 measures the first voltage by detecting an amount of reflection coefficient of the antenna 110 coupled to a radio in a first path using a detection circuit 108. The detection circuit 108 generates, using the amount of reflection coefficient, the voltage waveform. The amount of reflection coefficient varies in response to changes in impedance of the antenna 110. Although various embodiments described herein are directed to a single object being detected, in other embodiments, the antenna 110, the tap classification logic 104, and the detection circuit 108 can detect and classify multiple objects concurrently or simultaneously, such as multi-finger touches or sequence of touches. These can be used for more advance gestures. That is simultaneous touches can have different signal signatures, permitting more complex gestures. These touches can be simultaneous touches, concurrent touches, or sequential touches in a predetermined order. Also, the event of touching two or more points simultaneously (e.g., touching with two fingers) can have a unique signature and, therefore, can be distinguishable from other touch events, and is itself a legitimate touch event.

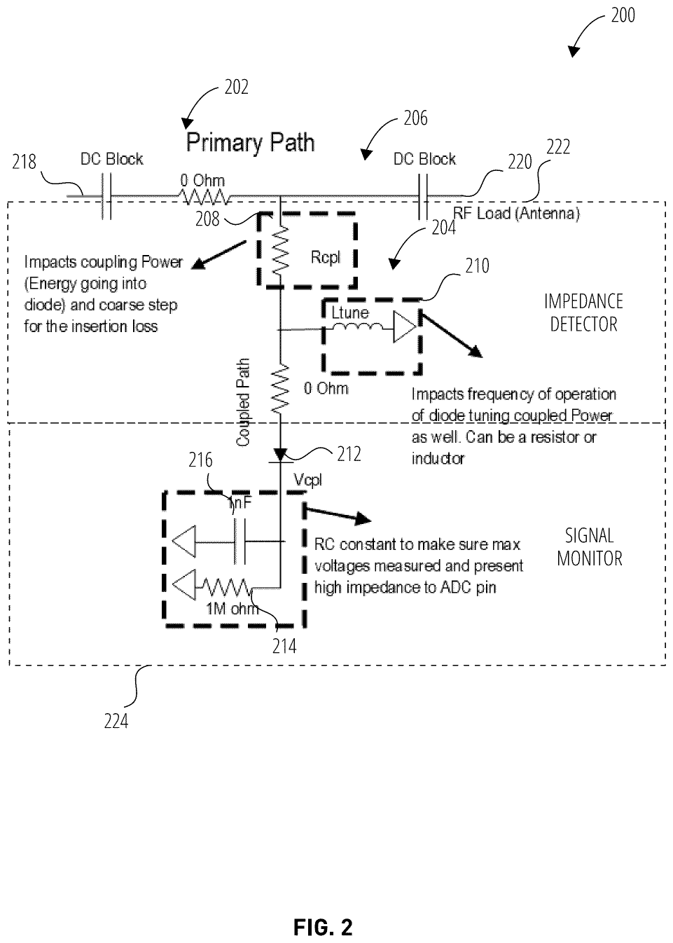

In at least one embodiment, the detection circuit 108 can include a resistive-coupled circuit to detect an impedance of the antenna 110, such as described in more detail below with respect to FIG. 2. In at least one embodiment, the detection circuit 108 includes the components of the detection circuit 200. Alternatively, other detection circuits can be used to translate the antenna's instantaneous characteristics into the time varying output signal 114, defined as s(t).

FIG. 2 is a schematic diagram of a detection circuit 200 that detects and converts an amount of reflected power in an RF path 202 (also referred to as primary path or first path) to a voltage waveform according to at least one embodiment. The RF path 202 is between an RF input 218 and an RF load 220 (antenna 110). The RF path 202 can include direct current (DC) blocks and an optional resistor. The optional resistor is illustrated as zero ohms, but the resistor can have other resistances based on design considerations. As described herein, the amount of reflected power in the RF path 202 varies in response to changes in impedance of an RF load 220 (antenna 110). In at least one embodiment, the detection circuit 200 includes a shunt load in front of the RF load 220 (antenna 110) and an envelope detection diode circuit.

In at least one embodiment, the detection circuit 200 includes an impedance detector 222 and a signal monitor 224. The impedance detector 222 is a circuit placed in front of the antenna 110 in a shunt path (parallel path) to the RF path 202. As illustrated in the embodiment of FIG. 2, the impedance detector 222 includes (i) a first resistor 208 (Rcpl) that regulates an amount of power coupled in a “coupled path” 204, and (ii) an inductor 210 (Ltune) (or a third resistor (Rtune)) that adjusts an output of the signal monitor 224 in a specified frequency band. The first resistor 208 can impact a “coupled power” (i.e., energy going into signal monitor 224) and coarse step for the insertion loss. The inductor 210 (or third resistor) can impact the frequency of operation of the signal monitor 224 by tuning the coupled power as well. The signal monitor 224 is a circuit that can monitor a signal generated by the impedance detector 222. As illustrated in the embodiment of FIG. 2, the signal monitor 224 is an envelope detector diode and accompanying capacitor and resistor elements.

The impedance detector 222 can present a suitably low Insertion Loss (i.e., it draws little power away from the transmitted power). For example, the first resistor 208 can have a large resistance, such as Rcpl=300 Ohms, to present a low insertion loss in the RF path 202. The impedance detector 222 can contain circuit elements in an architecture or topology such that the signal across one or more elements is some function of the impedance of the antenna 110, Zant. For example, a balanced Wheatstone bridge or other circuits can provide a voltage signal across a resistor in the circuit, which is directly proportional to a commonly used quantity, the antenna Reflection Coefficient, S11=(Zant−Zo)/(Zant+Zo), where Zo is some fixed reference impedance, typically 50 Ohms. Zant and, consequently, S11 (Reflection Coefficient), change when an object approaches the antenna. However, the proportionality constant is fixed, for all frequencies, regardless of the antenna and its variations. The embodiment shown in the disclosure is simpler than the Wheatstone bridge (lower cost) but it gives us a voltage signal across the Ltune which is not as neatly proportional to Zant, or S11.

In other embodiments, the impedance detector 222 can present two or more signals of interest to be monitored and/or compared via multiple signal monitor circuits (e.g., phase detectors).

An ideal signal monitor would not change the signal it monitors. But realistic circuits do. Such is, for example, the case with the envelope detector circuit of FIG. 2. With the diode parasitics in mind, the choice of the inductor 210 (Ltune) has been made to ensure enough power going into the diode detector. This can ensure good sensitivity in monitoring changes of the voltage signal across the inductor 210 (Ltune). For the diode to perform as an envelope detector, the value of the inductor 210 (Ltune) can be selected so that the voltage across it is low enough so as not to be “clipped” by the diode. The description above describes the physical characteristics of the impedance detector 222 and the signal monitor 224. In other embodiments, other circuits can be used to detect a change in the impedance of the antenna for detecting a presence of an object in proximity to the antenna.

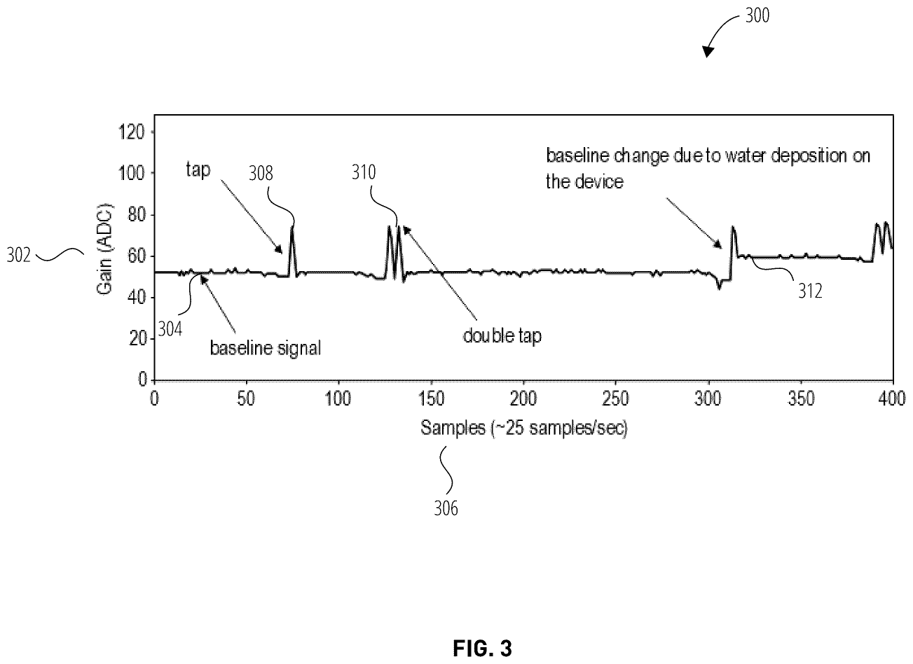

On the RF path 202 (also referred to as the primary path), the voltage can include an “incident” and a “reflected” wave component. When the radio transmits a signal, the incident wave travels toward the antenna 110. The reflected wave is reflected by the antenna and travels back towards the radio. The reflected-to-incident wave ratio is the aforementioned S11 quantity (Reflection Coefficient). When there is no reflected wave from the antenna, S11=0, and the signal monitored by the envelope detector circuit of a Wheatstone bridge detector will be zero. However, using the impedance detector 222 of FIG. 2, the monitored signal will have a non-zero value even if S11=0 (i.e., even if there is no reflected wave). In at least one embodiment, as illustrated in FIG. 2, the detection circuit 200 is a resistive-coupled circuit with a Schottky diode 212. The resistive-coupled circuit includes an unequal resistor divider 206 with (i) a first resistor 208 that regulates an amount of power coupled in a “coupled path” 204 (also referred to as second path or tapped path) and an insertion loss in the RF path 202. The first resistor 208 can impact a “coupled power” (i.e., energy going into Schottky diode 212) and coarse step for the insertion loss. The resistive-coupled circuit includes (ii) an inductor 210 (or a third resistor, or a combination thereof) that adjusts an output of the Schottky diode 212 (also referred to as a Schottky envelope detector diode) in a specified frequency band. The inductor 210 (or third resistor) can impact the frequency of operation of the Schottky diode 212 by tuning the coupled power as well. The Schottky diode 212 can convert an alternative current (AC) signal into a pulsating direct current (DC) signal. The resistive-coupled circuit includes a second resistor 214 and a capacitor 216, each coupled to the Schottky diode 212 and coupled in parallel to one another. The pulsating DC signal charges the capacitor 216 during positive half-cycles and discharges through the second resistor 214 during gaps between the half-cycles to obtain the envelope of the voltage waveform. The second resistor 214 and capacitor 216 provide an RC constant to make sure an accurate envelope of the voltage waveform is measured and present a high impedance to an ADC channel (i.e., ADC pin) of a processing device coupled to the output (Vcpl) of the Schottky diode 212. The ADC of the processing device can convert the voltage waveform into digital data to detect a change in impedance. As described in more detail below, the change in impedance can be determined to satisfies a criterion (e.g., exceed a first threshold) for event detection by a classifier. Similarly, audio data can be determined to satisfy a criterion for event detection by the classifier. Satisfying the criterion can represent a possible touch event caused by a physical interaction caused by a presence of an object in proximity to the RF load 220 (antenna 110). The processing device can perform an action in response to a classification of the touch event by the classifier. It should be noted that there are other conventional circuits that can detect and measure an absolute impedance of an antenna. The embodiments described herein rely on variations of the antenna impedance for event detection. The embodiments described herein can be used in various devices in spite of the variability from user to user or device to device. The detection circuit 200 can output an output signal, s(t), to the processing device for processing by the tap classification logic 104. The level of the output signal, s(t), from the detection circuit 200, can be adjusted by the appropriate choice of its constituent components. FIG. 2 illustrates one embodiment of the detection circuit. Alternatively, other detection circuits can be used. Additional details of the tap classification logic 104 (i.e., detection algorithm) are described below with respect to FIG. 3 to FIG. 21.

FIG. 3 is a graph 300 illustrating an output signal of a detection circuit during normal communication transmissions of a radio according to at least one embodiment. As described herein, the output signal can be sampled by the ADC during transmissions to produce samples 306. Each sample has a corresponding gain value 302 (also referred to as an amplitude value) measured by the detection circuit. The temporal behavior of the output signal can be used by the tap classification logic to establish a baseline 304 (also referred to as a baseline signal). Then monitored variations from the baseline 304 can be mapped onto suitable user gestures and interpreted as intentional user commands to alter a state and/or operation of the device. For example, as illustrated in FIG. 3, a single tap 308 on the device can result in a change in gain values 302 above the baseline 304 as a single spike. The single spike can exceed the baseline 304 by a threshold amount. For example, a single tap on an earbud during audio streaming could be detected as the tap 308 and enable a “skip track” function, a play function, a pause function, or the like. Other gestures and actions are possible. For another example, as illustrated in FIG. 3, a double tap 310 on the device can result in a change in gain values 302 above the baseline as two spikes within a specified amount of time. For example, a double tap on an earbud during audio streaming could be detected as the double tap 310 and enable a “skip track” function, a play function, a pause function, or the like.

As described herein, since the tap classification logic 104 relies on variations of the antenna impedance for gesture detection (instead of absolute impedance), the baseline 304 can change due to environmental or wearing conditions. For example, as illustrated in FIG. 3, the baseline 304 can experience a baseline change 312 to a higher level due to liquid deposition on the device. It should be noted that the antenna placement and sensitivity of the detection circuit can be adjusted to adjust a distance of an object can be reliably detected.

In at least one embodiment, the output signal, s(t), is sampled during normal communication transmissions of the radio. Depending on the radio, certain transmissions may be easier to handle for the purpose of gesture detection. For example, for Bluetooth Low Energy (BLE) radios, the tap classification logic samples the output signal, s(t), using the ADC during the advertising transmissions at one or more of the three advertising channels (i.e., 2402, 2426, and 2480 MHz).

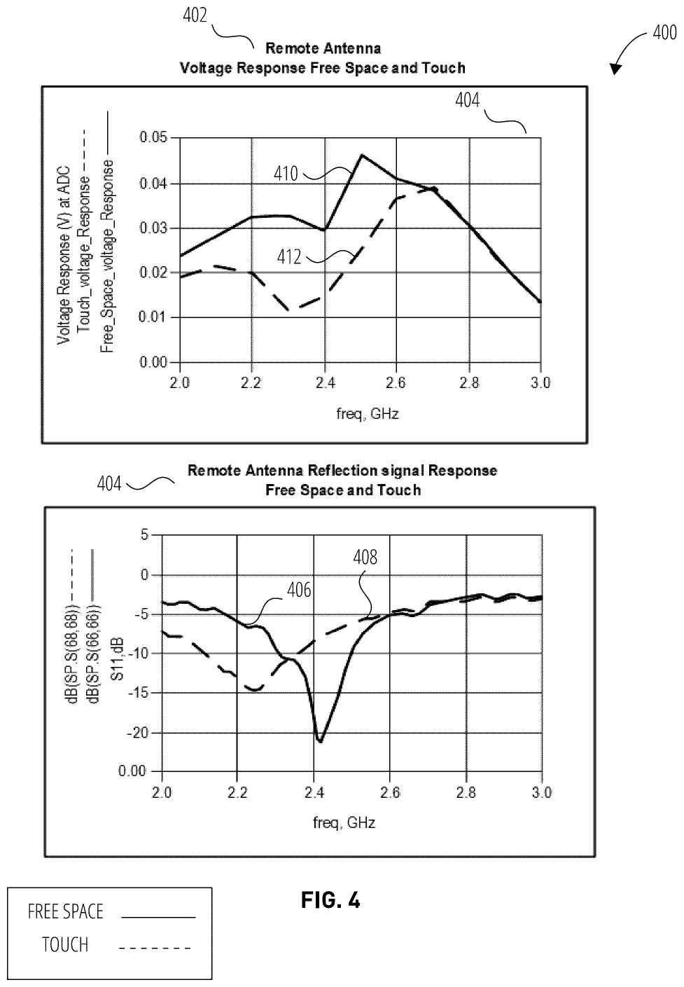

As described herein, a detection circuit is used to convert the reflected power to voltage, and this change in voltage level is used by a detection algorithm (tap classification logic) to map to different use cases described herein. The detection circuit can be a low-cost detection circuit. The detection circuit can be various types of topologies, including a resistive-coupled topology with a Schottky envelope detector diode. This technology can use an existing ADC in the processing device (or SoC). The detection circuit can be used in other devices with remote antennas, ring doorbell antennas with external ADCs, or the like. The impedance change that causes changes in reflected power as captured in a voltage waveform is shown and described below with respect to FIG. 4.

FIG. 4 illustrates graphs 400 of a voltage response 402 in free space and in the presence of an object using a remote antenna and a graph of a reflection signal response 404 in free space in the presence of an object using the remote antenna according to at least one embodiment. In this embodiment, a remote control device has a pigtail antenna coupled to a detection circuit inside the remote control device. When an object is not in proximity to the remote control device, a free space reflection signal response 406 is detected at the detection circuit. When the object is in proximity to or touching the remote control device, a touch reflection signal response 408 is detected at the detection circuit. The free space reflection signal response 406 and touch reflection signal response 408 can be the reflection coefficient in decibels (dBs). The change between the free space reflection signal response 406 and touch reflection signal response 408 shows the impact caused by a touch event on the remote control device. As illustrated in the free space reflection signal response 406 and touch reflection signal response 408 can be differentiated over a frequency range of approximately 2.3 GHz to 2.6 GHz.

Similarly, when an object is not in proximity to the remote control device, a free space voltage response 410 is measured at the ADC. When the object is in proximity to or touching the remote control device, a touch voltage response 412 is measured at the ADC. As illustrated in the free space voltage response 410 and touch voltage response 412 can be differentiated over a frequency range of approximately 2.0 GHz to 2.7 GHz.

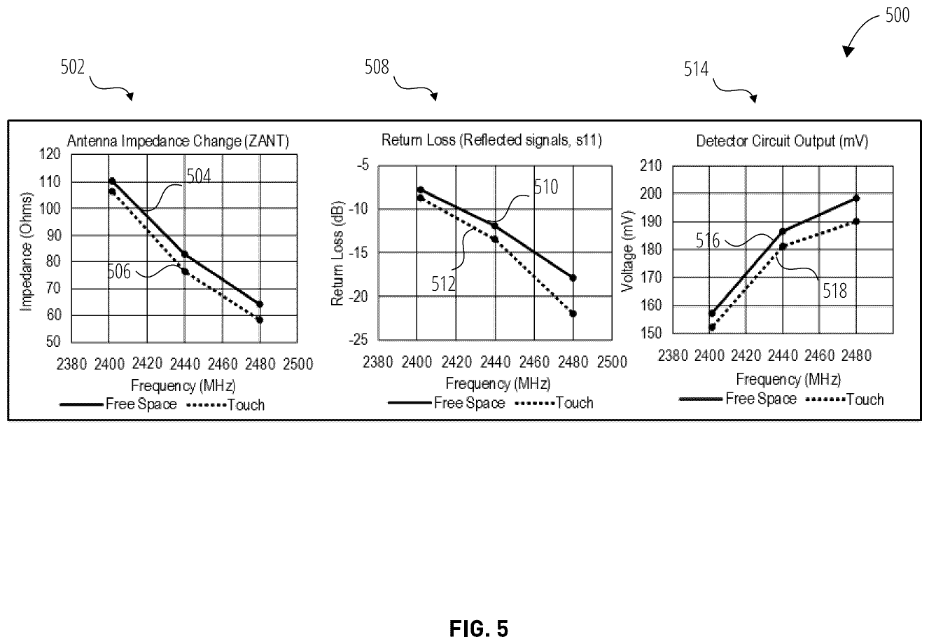

As described above, there can be a tradeoff between the insertion loss and coupled power. The amount of coupled power and, consequently, of the detection voltage depends on the antenna impedance (Zant) and varies with the variations of Zant, as shown and described below with respect to FIG. 5.

FIG. 5 illustrates graphs 500 of antenna impedance change, return loss, and detector circuit output signals according to at least one embodiment. FIG. 5 shows the change in the antenna impedance due to the touch impacting the reflected power in the RF Path, which is detected at the detector output. A first graph 502 illustrates an antenna impedance magnitude change 504 (Zant) in free space versus an antenna impedance magnitude change 506 with a presence of an object. A second graph 508 illustrates a return loss 510 in free space versus a return loss 512 with a presence of an object. A third graph 514 illustrates a detector circuit output 516 in free space versus a detector circuit output 518 with a presence of an object. There can be some dependencies on the ADC. For example, the number of ADC steps and the step size determine what which gestures can be detected and differentiated.

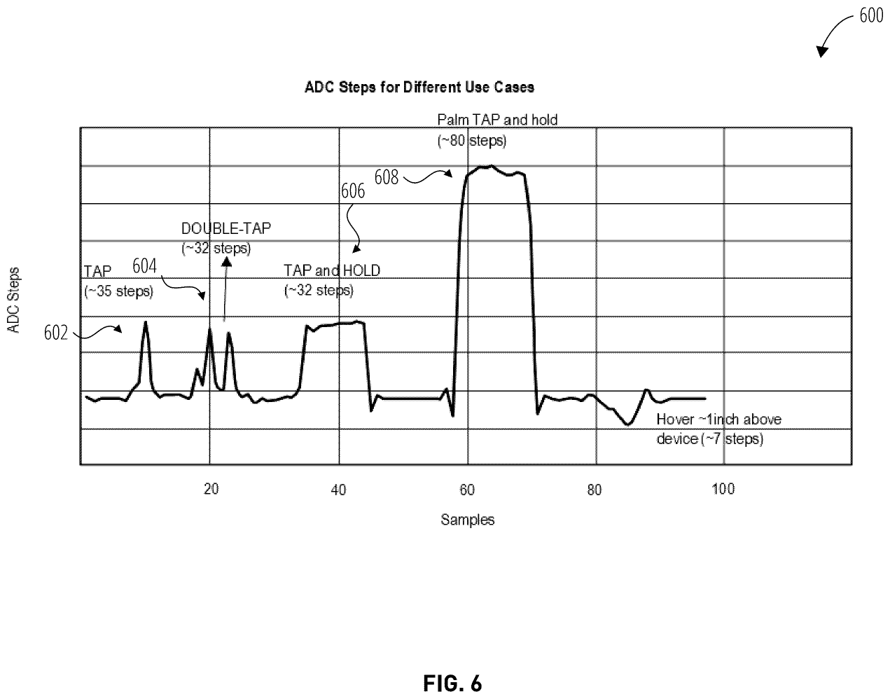

FIG. 6 is a graph 600 showing ADC steps for different use cases according to at least one embodiment. Graph 600 includes ADC steps corresponding to a tap 602, a double tap 604, a tap and hold 606, and a palm tap and hold 608. The tap 602 is a single spike in the ADC steps. The double tap 604 has two spikes within a specified amount of time. The tap and hold 606 has a rising edge, a first level of ADC steps for a specified amount of time, and a falling edge. The palm tap and hold 608 has a rising edge, a second level of ADC steps for a specified amount of time, and a falling edge. The second level is higher than the first level.

As described above, the A2S signals can be used by themselves to identify some possible events. However, the A2S signals and microphone signals can be preprocessed and used as separate inputs or combined inputs to a neural network classifier to predict a tap gesture or a “non-tap” (i.e., any action that is not an intentional tap on the surface of the device by a user). Additional details of using the A2S signals and microphone signals to detect physical interactions are described below with respect to FIG. 7 to FIG. 21.

FIG. 7 illustrates a block diagram of a system 700 with tap classification logic configured to perform multi-branched sensor fusion and event detection according to at least one embodiment. For example, the system 700 may be configured to receive input data (e.g., audio data and/or A2S data), independently process the input data prior to generating fused data, and perform event detection using the fused data. Although FIG. 7, and other figures/discussion illustrate the operation of the system in a particular order, the steps described may be performed in a different order (as well as certain steps removed or added) without departing from the intent of the disclosure.

As illustrated in FIG. 7, a system 700 may include a device 702 that may include one or more microphone 704 and/or one or more loudspeaker 706. However, the disclosure is not limited thereto and the device 702 may include additional components without departing from the disclosure. While FIG. 7 illustrates the loudspeaker(s) 706 being internal to the device 702, the disclosure is not limited thereto and the loudspeaker(s) 706 may be external to the device 702 without departing from the disclosure. For example, the loudspeaker(s) 706 may be separate from the device 702 and connected to the device 702 via a wired connection and/or a wireless connection without departing from the disclosure.

The device 702 may be an electronic device configured to send audio data to a remote device (not illustrated) and/or generate output audio. For example, the device 702 may perform speech processing to interpret a voice command from a user that is represented in audio data captured by the microphone(s) 704. In some examples, the device 702 may send the audio data to a remote system to perform speech processing and may receive an indication to perform an action in response to the voice command.

To illustrate an example, the microphone(s) 704 may generate microphone audio data xₘ(t) that may include a voice command, which may be indicated by a keyword (e.g., wakeword). For example, the device 702 detect that the wakeword is represented in the microphone audio data xₘ(t) and may cause language processing to be performed on the microphone audio data xₘ(t). Thus, a language processing component associated with the device 702 and/or a remote device may determine a voice command represented in the microphone audio data xₘ(t) and may perform an action corresponding to the voice command (e.g., execute a command, send an instruction to the device 702 and/or other devices to execute the command, etc.). In some examples, to determine the voice command the language processing component may perform Automatic Speech Recognition (ASR) processing, Natural Language Understanding (NLU) processing and/or command processing. The voice commands may control the device 702, audio devices (e.g., play music over loudspeaker(s) 706, capture audio using microphone(s) 704, or the like), multimedia devices (e.g., play videos using a display, such as a television, computer, tablet or the like), smart home devices (e.g., change temperature controls, turn on/off lights, lock/unlock doors, etc.) or the like.

To detect user speech or other audio, the device 702 may use the microphone(s) 704 to generate microphone audio data that captures audio in a room in which the device 702 is located (e.g., an environment of the device 702). As is known and as used herein, “capturing” an audio signal includes a microphone transducing audio waves (e.g., sound waves) of captured sound to an electrical signal and a codec digitizing the signal to generate the microphone audio data. In some examples, the microphone(s) 704 may be included in a microphone array, such as an array of eight microphones. However, the disclosure is not limited thereto and the device 702 may include any number of microphones 704 without departing from the disclosure.

The device 702 may generate output audio corresponding to an alarm, corresponding to audio data stored on the device 702, and/or corresponding to audio data received from a remote device. For example, the device 702 may generate an alarm notification by sending alarm output audio data to the loudspeaker(s) 706. However, the disclosure is not limited thereto and the device 702 may receive playback audio data from a remote device and may generate output audio using the playback audio data.

To improve a user interface, the device 702 may detect when a tap event occurs on a surface of the device 702, along with other events/activity, using a multi-branched network for sensor fusion. For example, instead of using a physical sensor to detect the tap event, the device 702 may detect a tap event using a combination of microphone audio data and A2S data, such as A2S data generated by a A2S system (e.g., A2S). Prior to combining these inputs for further inference, the device 702 may use separate neural networks to independently extract features from the audio data and the A2S data. This multi-branch approach improves an accuracy of tap detection and enables detection of additional tap gestures and/or other types of event/activity detection (e.g., typing detection).

In some examples, the multi-branched network may generate fused data by processing audio features and A2S data. In other examples, the multi-branched network may generate the fused data by processing raw audio data, raw A2S data, and/or optional sensor data. Depending on the inputs, a number of branches, a branch depth, and/or a number of event detectors may vary without departing from the disclosure. The device 702 may process the fused data to detect a tap event and perform an action. For example, the device 702 may interpret a detected tap event as an input to delay or end an alarm, turn a light switch on or off, turn music on or off, and/or the like, although the disclosure is not limited thereto.

Additionally or alternatively, the device 702 may process the fused data using two or more event/activity detectors, enabling the device 702 to detect multiple physical interaction events based on a common input. In some examples, the device 702 may distinguish between multiple tap events based on a location of the tap event. For example, the device 702 may distinguish between a first location associated with a first microphone and a second location associated with a second microphone, enabling the device 702 to perform two separate actions depending on a location of the tap event. In other embodiments, multiple antennas (or a single antenna with unique characteristics) can be used to distinguish between multiple locations.

As used herein, performing tap detection may refer to the device 702 applying a tap detection algorithm, detecting a tap event, detecting when a tap event occurs, detecting a physical interaction with the device, and/or the like without departing from the disclosure. For example, the device 702 may apply the tap detection algorithm to monitor for potential tap events and, in response to detecting a tap event, may generate event data indicating that the tap event occurred. Additionally or alternatively, performing event detection may refer to the device 702 applying an event detection algorithm, detecting an event/activity, detecting when an event/activity occurs, and/or the like without departing from the disclosure.

Performing tap detection and/or event detection using only audio data may result in false positives, however. For example, loud noises in proximity to the device 702 (e.g., clapping, snapping, etc.), wind noise (e.g., caused by wind, a nearby fan, etc.), and/or other non-tap events may cause the device 702 to detect a tap event when no physical tap occurred. To reduce these false positives, the device 702 may perform tap detection and/or event detection using a combination of audio data and A2S data (i.e., impedance data). For example, the device 702 may use both the audio data and the A2S data to perform tap detection using a trained model, such as a machine learning model, neural network, convolutional neural network (CNN), deep neural network (DNN), transformer network, multilayer perceptron (MLP) network (e.g., fully connected network), feedforward artificial neural network, other architecture, and/or a combination thereof. For example, the tap event may correspond to a physical interaction with the device, comprising at least one of a swipe, tap, or button press, although the disclosure is not limited thereto.

As illustrated in FIG. 7, the device 702 may generate A2S data (block 708) and may determine first feature data corresponding to the A2S data (block 710). For example, the device 702 may process the A2S data using a first neural network (e.g., first convolutional layers) to determine the first feature data. In some examples, the A2S data may correspond to a multi-channel waveform generated by an A2S system of the device 702 and may therefore represent impedance of the antenna.

Separately from determining the first feature data, the device 702 may generate audio data corresponding to one or more microphone(s) 704 (block 712) and may determine second feature data corresponding to the audio data (block 714). For example, the device 702 may process the audio data using a second neural network (e.g., second convolutional layers) to determine the second feature data, as described in greater detail below.

As used herein, unprocessed data generated by a sensor component may be referred to as raw data (e.g., raw A2S data, raw audio data, etc.) and may correspond to a first series of values representing an input captured by a sensor component (e.g., microphone, A2S system, etc.). In some examples, the device 702 may process the raw data to generate processed data, which may correspond to a second series of values representing the input similarly to the raw data. For example, raw audio data may include a first representation of speech and a first representation of noise and the device 702 may perform audio processing on the raw audio data to generate processed audio data that includes a second representation of the speech and a second representation of the noise, such that the second representation of the noise reduces an amount of noise and/or distortion relative to the first representation of the noise. In other examples, however, the device 702 may process the raw data to generate feature data, which may correspond to a third series of processed values derived from the first series and/or the second series of values without departing from the disclosure. Thus, the device 702 may generate feature data based on the raw data and/or the processed data without departing from the disclosure.

As used herein, “data” may refer to raw data, processed data, and/or feature data without departing from the disclosure. For example, the A2S data generated at block 708 may refer to raw A2S data, processed A2S data, and/or feature data derived from the raw A2S data and/or the processed A2S data without departing from the disclosure. Additionally or alternatively, the audio data generated at block 712 may refer to raw audio data, processed audio data, and/or feature data derived from the raw audio data and/or the processed audio data without departing from the disclosure.

Using the first feature data and the second feature data, the device 702 may generate fused data (block 716), may determine inference data by processing the fused data (block 718), and may perform event/activity detection using the inference data (block 720). For example, the device 702 may concatenate the first feature data and the second feature data and process the fused data using one or more event detectors without departing from the disclosure. In some examples, the device 702 may process the fused data using two or more event detectors, enabling the device 702 to detect two different types of event/activity, although the disclosure is not limited thereto.

While FIG. 7 illustrates an example in which the device 702 generates the second feature data using the audio data, the disclosure is not limited thereto. Instead, the device 702 may generate second feature data using the A2S data at block 708 and may generate first feature data using the audio data at block 712 without departing from the disclosure. Thus, while FIG. 7 illustrates an example in which the fused data is generated based on feature data, the disclosure is not limited thereto and the device 702 may generate the fused data based on first A2S data and second A2S data without departing from the disclosure.

An audio signal is a representation of sound and an electronic representation of an audio signal may be referred to as audio data, which may be analog and/or digital without departing from the disclosure. For ease of illustration, the disclosure may refer to either audio data (e.g., reference audio data or playback audio data, microphone audio data or input audio data, etc.) or audio signals (e.g., playback signals, microphone signals, etc.) without departing from the disclosure. For example, some audio data may be referred to as playback audio data, microphone audio data, error audio data, output audio data, and/or the like. Additionally or alternatively, this audio data may be referred to as audio signals such as a playback signal, microphone signal, error signal, output audio data, and/or the like without departing from the disclosure.

Additionally or alternatively, portions of a signal may be referenced as a portion of the signal or as a separate signal and/or portions of audio data may be referenced as a portion of the audio data or as separate audio data. For example, a first audio signal may correspond to a first period of time (e.g., 30 seconds) and a portion of the first audio signal corresponding to a second period of time (e.g., 1 second) may be referred to as a first portion of the first audio signal or as a second audio signal without departing from the disclosure. Similarly, first audio data may correspond to the first period of time (e.g., 30 seconds) and a portion of the first audio data corresponding to the second period of time (e.g., 1 second) may be referred to as a first portion of the first audio data or second audio data without departing from the disclosure. Audio signals and audio data may be used interchangeably, as well; a first audio signal may correspond to the first period of time (e.g., 30 seconds) and a portion of the first audio signal corresponding to a second period of time (e.g., 1 second) may be referred to as first audio data without departing from the disclosure.

In some examples, the audio data may correspond to audio signals in a time-domain. However, the disclosure is not limited thereto and the device 702 may convert these signals to a sub-band-domain or a frequency-domain prior to performing additional processing, such as acoustic echo cancellation (AEC), noise reduction (NR) processing, adaptive interference cancellation (AIC) processing, and/or the like. For example, the device 702 may convert the time-domain signal to the sub-band-domain by applying a bandpass filter or other filtering to select a portion of the time-domain signal within a desired frequency range. Additionally or alternatively, the device 702 may convert the time-domain signal to the frequency-domain using a Fast Fourier Transform (FFT) and/or the like.

As used herein, audio signals or audio data (e.g., microphone audio data, or the like) may correspond to a specific range of frequency bands. For example, the audio data may correspond to a human hearing range (e.g., 20 Hz-20 kHz), although the disclosure is not limited thereto.

As used herein, a frequency band corresponds to a frequency range having a starting frequency and an ending frequency. Thus, the total frequency range may be divided into a fixed number (e.g., 256, 412, etc.) of frequency ranges, with each frequency range referred to as a frequency band and corresponding to a uniform size. However, the disclosure is not limited thereto and the size of the frequency band may vary without departing from the disclosure.

Playback audio data xᵣ(t) (e.g., far-end reference signal) corresponds to audio data that will be output by the loudspeaker(s) 706 to generate playback audio (e.g., echo signal y(t)). For example, the device 702 may stream music or output speech associated with a communication session (e.g., audio or video telecommunication). In some examples, the playback audio data may be referred to as far-end reference audio data, loudspeaker audio data, and/or the like without departing from the disclosure. For ease of illustration, the following description will refer to this audio data as playback audio data or reference audio data. As noted above, the playback audio data may be referred to as playback signal(s) xᵣ (t) without departing from the disclosure.

Microphone audio data xₘ(t) corresponds to audio data that is captured by one or more microphone(s) 704 prior to the device 702 performing audio processing such as AEC processing or beamforming. The microphone audio data xₘ(t) may include local speech s(t) (e.g., an utterance, such as near-end speech generated by the user), an “echo” signal y(t) (e.g., portion of the playback audio xᵣ(t) captured by the microphone(s) 704), acoustic noise n(t) (e.g., ambient noise in an environment around the device 702), and/or the like. As the microphone audio data is captured by the microphone(s) 704 and captures audio input to the device 702, the microphone audio data may be referred to as input audio data, near-end audio data, and/or the like without departing from the disclosure. For ease of illustration, the following description will refer to this signal as microphone audio data. As noted above, the microphone audio data may be referred to as a microphone signal without departing from the disclosure.

An “echo” signal y(t) corresponds to a portion of the playback audio that reaches the microphone(s) 704 (e.g., portion of audible sound(s) output by the loudspeaker(s) 706 that is recaptured by the microphone(s) 704 and may be referred to as an echo or echo data y(t). If the device 702 includes a single loudspeaker 706, an acoustic echo canceller (AEC) may perform acoustic echo cancellation for one or more microphone(s) 704. However, if the device 702 includes multiple loudspeakers loudspeaker(s) 706, a multi-channel acoustic echo canceller (MC-AEC) may perform acoustic echo cancellation. For ease of explanation, the disclosure may refer to removing estimated echo audio data from microphone audio data to perform acoustic echo cancellation. The system 700 removes the estimated echo audio data by subtracting the estimated echo audio data from the microphone audio data, thus cancelling the estimated echo audio data. This cancellation may be referred to as “removing,” “subtracting” or “cancelling” interchangeably without departing from the disclosure.

In some examples, the device 702 may perform echo cancellation using the playback audio data. However, the disclosure is not limited thereto, and the device 702 may perform echo cancellation using the microphone audio data, such as adaptive noise cancellation (ANC), adaptive interference cancellation (AIC), and/or the like, without departing from the disclosure. As used herein, isolated audio data corresponds to audio data after the device 702 performs audio processing (e.g., AEC processing, RES processing, AIC processing, ANC processing, and/or the like) to isolate the local speech s(t).

In some examples, such as when performing echo cancellation using ANC/AIC processing, the device 702 may include a beamformer that may perform audio beamforming on the microphone audio data to determine target audio data (e.g., audio data on which to perform echo cancellation). The beamformer may include a fixed beamformer (FBF) and/or an adaptive noise canceller (ANC), enabling the beamformer to isolate audio data associated with a particular direction. The FBF may be configured to form a beam in a specific direction so that a target signal is passed and all other signals are attenuated, enabling the beamformer to select a particular direction (e.g., directional portion of the microphone audio data). In contrast, a blocking matrix may be configured to form a null in a specific direction so that the target signal is attenuated and all other signals are passed (e.g., generating non-directional audio data associated with the particular direction).

The beamformer may generate fixed beamforms (e.g., outputs of the FBF) or may generate adaptive beamforms (e.g., outputs of the FBF after removing the non-directional audio data output by the blocking matrix) using a Linearly Constrained Minimum Variance (LCMV) beamformer, a Minimum Variance Distortion-less Response (MVDR) beamformer or other beamforming techniques. For example, the beamformer may receive audio input, determine six beamforming directions and output six fixed beamform outputs and six adaptive beamform outputs. In some examples, the beamformer may generate six fixed beamform outputs, six LCMV beamform outputs and six MVDR beamform outputs, although the disclosure is not limited thereto. Using the beamformer and techniques discussed below, the device 702 may determine target signals on which to perform acoustic echo cancellation using the AEC. However, the disclosure is not limited thereto and the device 702 may perform AEC without beamforming the microphone audio data without departing from the present disclosure. Additionally or alternatively, the device 702 may perform beamforming using other techniques known to one of skill in the art and the disclosure is not limited to the techniques described above.

As discussed above, the device 702 may include a microphone array having multiple microphone(s) 704 that are laterally spaced from each other so that they can be used by audio beamforming components to produce directional audio signals. The microphone(s) 704 may, in some instances, be dispersed around a perimeter of the device 702 in order to apply beampatterns to audio signals based on sound captured by the microphones. For example, the microphone(s) 704 may be positioned at spaced intervals along a perimeter of the device 702, although the present disclosure is not limited thereto. In some examples, the microphone(s) 704 may be spaced on a substantially vertical surface of the device 702 and/or a top surface of the device 702. Each of the microphone(s) 704 is omnidirectional, and beamforming technology may be used to produce directional audio signals based on audio data generated by the microphone(s) 704. In other embodiments, the microphone(s) 704 may have directional audio reception, which may remove the need for subsequent beamforming.

Using the microphone(s) 704, the device 702 may employ beamforming techniques to isolate desired sounds for purposes of converting those sounds into audio signals for speech processing by the system. Beamforming is the process of applying a set of beamformer coefficients to audio signal data to create beampatterns, or effective directions of gain or attenuation. In some implementations, these volumes may be considered to result from constructive and destructive interference between signals from individual microphone(s) 704 in a microphone array.

The device 702 may include a beamformer that may include one or more audio beamformers or beamforming components that are configured to generate an audio signal that is focused in a particular direction (e.g., direction from which user speech has been detected). More specifically, the beamforming components may be responsive to spatially separated microphone elements of the microphone array to produce directional audio signals that emphasize sounds originating from different directions relative to the device 702, and to select and output one of the audio signals that is most likely to contain user speech.

Audio beamforming, also referred to as audio array processing, uses a microphone array having multiple microphone(s) 704 that are spaced from each other at known distances. Sound originating from a source is received by each of the microphone(s) 704. However, because each microphone is potentially at a different distance from the sound source, a propagating sound wave arrives at each of the microphone(s) 704 at slightly different times. This difference in arrival time results in phase differences between audio signals produced by the microphones. The phase differences can be exploited to enhance sounds originating from chosen directions relative to the microphone array.

Beamforming uses signal processing techniques to combine signals from the different microphones so that sound signals originating from a particular direction are emphasized while sound signals from other directions are deemphasized. More specifically, signals from the different microphone(s) 704 are combined in such a way that signals from a particular direction experience constructive interference, while signals from other directions experience destructive interference. The parameters used in beamforming may be varied to dynamically select different directions, even when using a fixed-configuration microphone array.

As described above, the device 702 may generate microphone audio data xₘ(t) using microphone(s) 704. For example, a first microphone may generate first microphone audio data xₘ₁(t) in a time domain, a second microphone may generate second microphone audio data xₘ₂(t) in the time domain, and so on. As used herein, a time domain signal may be comprised of a sequence of individual samples of audio data, such that x(t) denotes an individual sample that is associated with a time t.

While the microphone audio data x(t) is comprised of a plurality of samples, in some examples the device 702 may group a plurality of samples and process them together. For example, the device 702 may group a number of samples together in a frame to generate microphone audio data x(n). As used herein, microphone audio data x(n) corresponds to the time-domain signal and identifies an individual frame (e.g., fixed number of samples s) associated with a frame index n.

Additionally or alternatively, the device 702 may convert microphone audio data x(n) from the time domain to the frequency domain or sub-band domain. For example, the device 702 may perform Discrete Fourier Transforms (DFTs) (e.g., Fast Fourier transforms (FFTs), short-time Fourier Transforms (STFTs), and/or the like) to generate microphone audio data X(n, k) in the frequency domain or the sub-band domain. As used herein, microphone audio data X(n, k) corresponds to the frequency-domain signal and identifies an individual frame associated with frame index n and tone index k. Thus, while the microphone audio data x(t) corresponds to time indexes, the microphone audio data x(n) and the microphone audio data X(n, k) corresponds to frame indexes.

A Fast Fourier Transform (FFT) is a Fourier-related transform used to determine the sinusoidal frequency and phase content of a signal and performing a FFT operation produces a one-dimensional vector of complex numbers. This vector can be used to calculate a two-dimensional matrix of frequency magnitude versus frequency. In some examples, the system 700 may perform FFT on individual frames of audio data and generate a one-dimensional and/or a two-dimensional matrix corresponding to the microphone audio data X(n). However, the disclosure is not limited thereto and the system 700 may instead perform short-time Fourier transform (STFT) operations without departing from the disclosure. A short-time Fourier transform is a Fourier-related transform used to determine the sinusoidal frequency and phase content of local sections of a signal as it changes over time.

Using a Fourier transform, a sound wave such as music or human speech can be broken down into its component “tones” of different frequencies, each tone represented by a sine wave of a different amplitude and phase. Whereas a time-domain sound wave (e.g., a sinusoid) would ordinarily be represented by the amplitude of the wave over time, a frequency domain representation of that same waveform comprises a plurality of discrete amplitude values, where each amplitude value is for a different tone or “bin.” So, for example, if the sound wave consisted solely of a pure sinusoidal 1 kHz tone, then the frequency domain representation would consist of a discrete amplitude spike in the bin containing 1 kHz, with the other bins at zero. In other words, each tone “k” is a frequency index (e.g., frequency bin). To illustrate an example, the system 700 may apply FFT processing to the time-domain microphone audio data x(n), producing the frequency-domain microphone audio data X(n,k), where the tone index “k” (e.g., frequency index) ranges from 0 to K and “n” is a frame index ranging from 0 to N. Thus, the history of the values across iterations is provided by the frame index “n,” which ranges from 1 to N and represents a series of samples over time.

In some examples, the device 702 may perform a K-point FFT on a time-domain signal. For example, if the device 702 performs a 256-point FFT on a 16 kHz time-domain signal, the output is 256 complex numbers, where each complex number corresponds to a value at a frequency in increments of 16 kHz/256, such that there is 125 Hz between points, with point 0 corresponding to 0 Hz and point 255 corresponding to 16 kHz. Thus, each tone index in the 256-point FFT corresponds to a frequency range (e.g., sub-band) in the 16 kHz time-domain signal. While the example above refers to the frequency range being divided into 256 different sub-bands (e.g., tone indexes), the disclosure is not limited thereto and the system 700 may divide the frequency range into K different sub-bands (e.g., K indicates an FFT size). In addition, while the example described above refers to the tone index being generated using the K-point FFT operation, the disclosure is not limited thereto. Instead, the tone index may be generated using Short-Time Fourier Transform (STFT), generalized Discrete Fourier Transform (DFT) and/or other transforms known to one of skill in the art (e.g., discrete cosine transform, non-uniform filter bank, etc.) without departing from the disclosure.

The system 700 may include multiple microphone(s) 704, with a first channel m corresponding to a first microphone, a second channel (m+1) corresponding to a second microphone, and so on until a final channel (M) that corresponds to microphone 112M. While some drawings illustrate four channels or eight channels, the disclosure is not limited thereto and the number of channels may vary. For the purposes of discussion, an example of system 700 includes “M” microphone(s) 704 (M>1) for hands free near-end/far-end distant speech recognition applications.

While the examples described above refer to the microphone audio data xₘ(t), the disclosure is not limited thereto and the same techniques apply to the playback audio data xᵣ(t) without departing from the disclosure. Thus, playback audio data xᵣ(t) indicates a specific time index t from a series of samples in the time-domain, playback audio data xᵣ(n) indicates a specific frame index n from series of frames in the time-domain, and playback audio data Xᵣ(n, k) indicates a specific frame index n and frequency index k from a series of frames in the frequency-domain.

Prior to converting the microphone audio data xₘ(n) and the playback audio data xᵣ(n) to the frequency-domain, in some examples the device 702 may first perform time-alignment to align the playback audio data xᵣ(n) with the microphone audio data xₘ(n). For example, due to nonlinearities and variable delays associated with sending the playback audio data xᵣ(n) to external loudspeaker(s) using a wireless connection, the playback audio data xᵣ(n) may not synchronized with the microphone audio data xₘ(n). This lack of synchronization may be due to a propagation delay (e.g., fixed time delay) between the playback audio data xᵣ(n) and the microphone audio data xₘ(n), clock jitter and/or clock skew (e.g., difference in sampling frequencies between the device 702 and the loudspeaker(s)), dropped packets (e.g., missing samples), and/or other variable delays.

To perform the time alignment, the device 702 may adjust the playback audio data xᵣ(n) to match the microphone audio data xₘ(n). For example, the device 702 may adjust an offset between the playback audio data xᵣ(n) and the microphone audio data xₘ(n) (e.g., adjust for propagation delay), may add/subtract samples and/or frames from the playback audio data xᵣ(n) (e.g., adjust for drift), and/or the like. In some examples, the device 702 may modify both the microphone audio data and the playback audio data in order to synchronize the microphone audio data and the playback audio data. However, performing nonlinear modifications to the microphone audio data results in first microphone audio data associated with a first microphone to no longer be synchronized with second microphone audio data associated with a second microphone. Thus, the device 702 may instead modify only the playback audio data so that the playback audio data is synchronized with the first microphone audio data, although the disclosure is not limited thereto.

In some examples, the device 702 may detect a tap event and perform a corresponding action. For example, the device 702 may interpret a detected tap event as an input to delay or end an alarm, turn a light switch on or off, turn music on or off, and/or the like, although the disclosure is not limited thereto. However, the disclosure is not limited thereto, and the device 702 may perform event detection without departing from the disclosure. For example, the device 702 may detect a typing event (e.g., user typing on a keyboard), detect mechanical operations (e.g., opening a door, operations performed by appliances, etc.), detect specific activity (e.g., chopping food in a kitchen), and/or the like, although the disclosure is not limited thereto.

### Signal Preprocessing—A2S Preprocessing

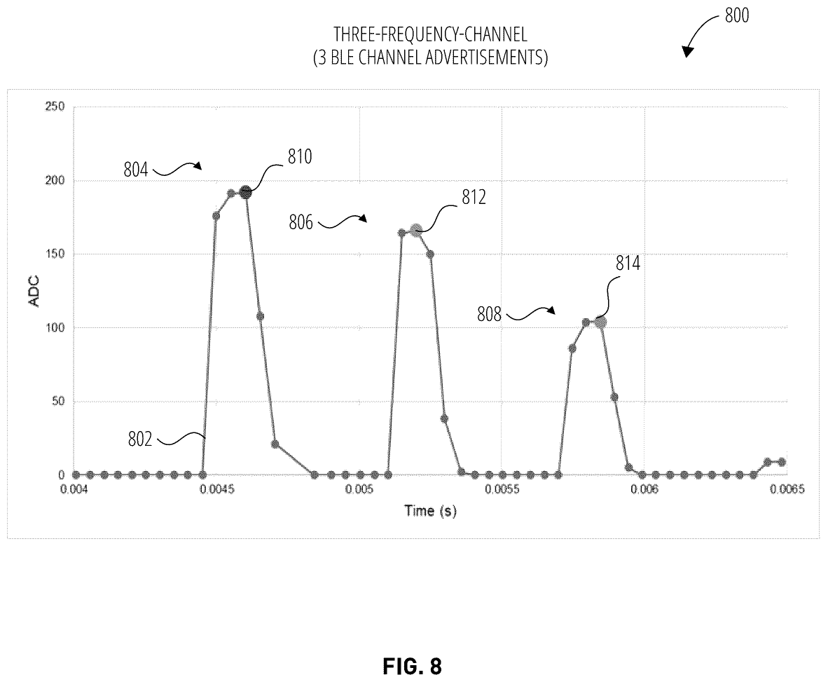

In at least one embodiment, the A2S signal is acquired by transmitting periodic BLE advertisement packets. BLE advertisement packets are a standard part of the BLE protocol. The advertisement include periodic transmission of data over the antenna over three channels, such as 2402, 2426, and 2480 MHz. The A2S detection circuit (e.g., detection circuit 108, detection circuit 200) converts impedance changes of the Bluetooth antenna into a voltage which can be digitized by the ADC of the CPU (e.g., 102). A sample A2S waveform is shown in FIG. 8.

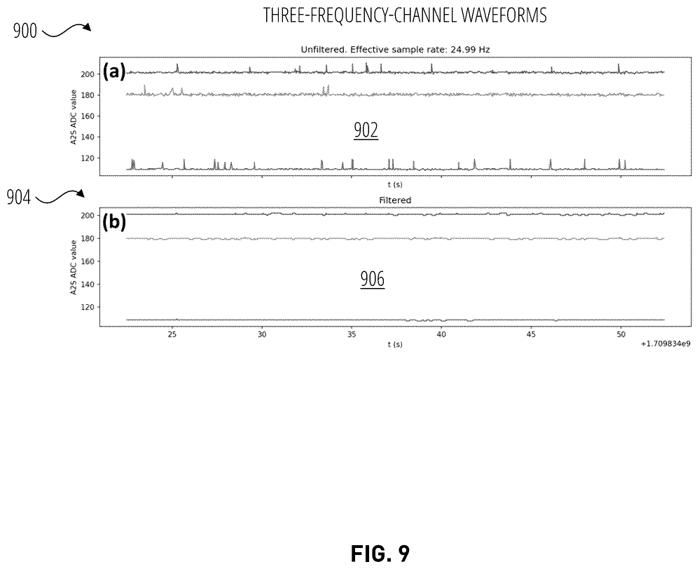

FIG. 8 is a graph 800 showing raw A2S signal 802, as measured by the ADC, from three sequential transmissions of a BLE advertisement packet over three Bluetooth channels according to at least one embodiment. In particular, a wireless device can send a first transmission of the BLE advertisement packet in a first channel, resulting in a first pulse 804 in the A2S signal 802. The wireless device can send a second transmission of the BLE advertisement packet in a second channel, resulting in a second pulse 806 in the A2S signal 802. The wireless device can send a third transmission of the BLE advertisement packet in a third channel. The sequential transmissions results in a sequential pattern of pulses in the A2S signal 802, as measured by the ADC. The tap classification logic 104 can identify the sequential pattern and extract a peak value of each pulse. In particular, the tap classification logic 104 can extract a first peak value 810 from the first pulse, a second peak value 812 from the second pulse 806, and a third peak value 814 from the third pulse 808. Extracting the peak values of each pulse leads to a three-channel, quasi-continuous waveform representing A2S signal 802 over time, as shown in FIG. 9.

FIG. 9 illustrates a first graph 900 of an unfiltered three-channel A2S signal 902 and a second graph 904 of a filtered three-channel A2S signal 906 according to at least one embodiment. As described above, the tap classification logic 104 can extract peak values from the three BLE advertisement packets to obtain the unfiltered three-channel A2S signal 902, as shown graph 900.

BLE advertisement can occur in parallel with normal wireless local area network (WLAN) operations, which includes numerous other transmissions at varying output power. Some of these transmissions overlap with the BLE advertisement peaks, leading to positive-polarity spikes visible in graph 900. To eliminate these spikes, the tap classification logic 104 can apply a rolling minimum filter to each channel of the unfiltered three-channel A2S signal 902 to get a smooth A2S baseline which is only modulated by antenna impedance changes caused by a nearby hand or object, as illustrated in the filtered three-channel A2S signal 906 of graph 904 (labeled (b)). That is, after extracting the peak values, the tap classification logic 104 can apply the rolling-minimum filter to obtain the filtered three-channel A2S signal 906.

It should be noted that, in this specific embodiment, the peak values are extracted from BLE advertisements for A2S signal processing. However, other embodiments may include ADC reads synchronized to BLE transmit pulses (e.g., interrupt triggering) that obviate pattern detection to extract the advertisement pulses from other transmissions, more sophisticated detection circuitry that can extract consistent A2S signal from any transmission (Wi-Fi vs. BLE and different transmit powers), or other techniques.

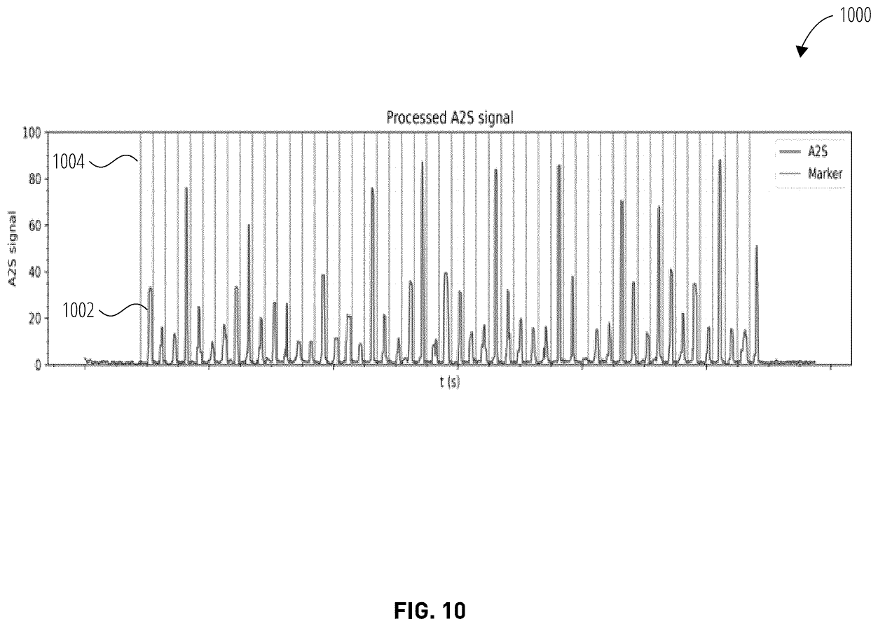

As illustrated in the graphs of FIG. 9, each channel of the three-channel A2S signal may fluctuate either positively or negatively depending on the excitation (e.g., location or angle of approach of the moving hand). A such, the tap classification logic 104 can further baseline-subtract and compute vector magnitude of the A2S signal to arrive at an input signal for a neural network. A sample plot of a fully preprocessed A2S signal is shown in FIG. 10.

FIG. 10 is a graph 1000 showing a preprocessed A2S signal 1002 according to at least one embodiment. As described above, the tap classification logic 104 can compute vector magnitudes of vector magnitude of baseline-subtracted, three-channel A2S signal to arrive at the preprocessed A2S signal 1002 an input signal for a neural network. Graph 1000 also shows vertical lines as markers 1004 to delineates individual taps made at various locations over a top hemisphere of a wireless device.

### Signal Preprocessing—Audio Preprocessing

Previous work in fusion tap detection for smart speakers leveraged audio features computed from raw, multi-channel microphone data. Specifically, Inter-channel Level Difference (ILD) and RMS microphone amplitude were extracted as the input to neural networks. In some embodiments, the tap classification logic 104 can compute similar audio features. In other embodiments, the audio can be preprocessed using other approaches, such as described in more detail below.

Modern smart speakers feature high loudness and bass, and the internal placement of microphones may be far below the outer surface of the speaker. As a result, ILD can be less effective at providing contrast between taps and self-excitation caused by speaker playback (e.g., loud music and beats). In at least one embodiment, to improve signal-to-background ratio for taps versus speaker output, the audio preprocessing can exploit internal high-pass filters used to prevent vibration and distortion of speaker playback. For example, a smart speaker device can include an internal, 30-Hz high-pass filter applied to the audio signal before playback on the loudspeaker(s). As a result, microphone recordings lack significant content in the 0-30-Hz range, even during max-volume playback. In at least one embodiment, the tap classification logic 104 can apply a 30-Hz low-pass digital filter along with smoothing on each individual microphone channel and averaging across microphones in order to produce an enhanced audio signal that is robust against speaker playback. In at least one embodiment, the tap classification logic 104 can down-sample the audio signal to be on the same scale as the sample rate for A2S signal (e.g., 25 Hz). As a result, the neural network can directly fuse the A2S and audio signals. In particular, the tap classification logic 104 can apply a 30-Hz low-pass digital filter to the audio data and down-sample the audio data from a first sampling rate to a second sampling rate (e.g., 25 Hz) to obtain a first waveform (e.g., the audio signal waveform representing audio excitations during a time window). The second sampling rate is equal to a sampling rate of the ADC that generates a second waveform (e.g., A2S signal waveform). With the same sampling rate, both the first waveform and the second waveform can be input directly into an ML model (e.g., classifier). Alternatively, the multi-branched fusion could be leveraged to combine disparate sample rates for the disparate sensing modalities.

### Tap Classification Logic

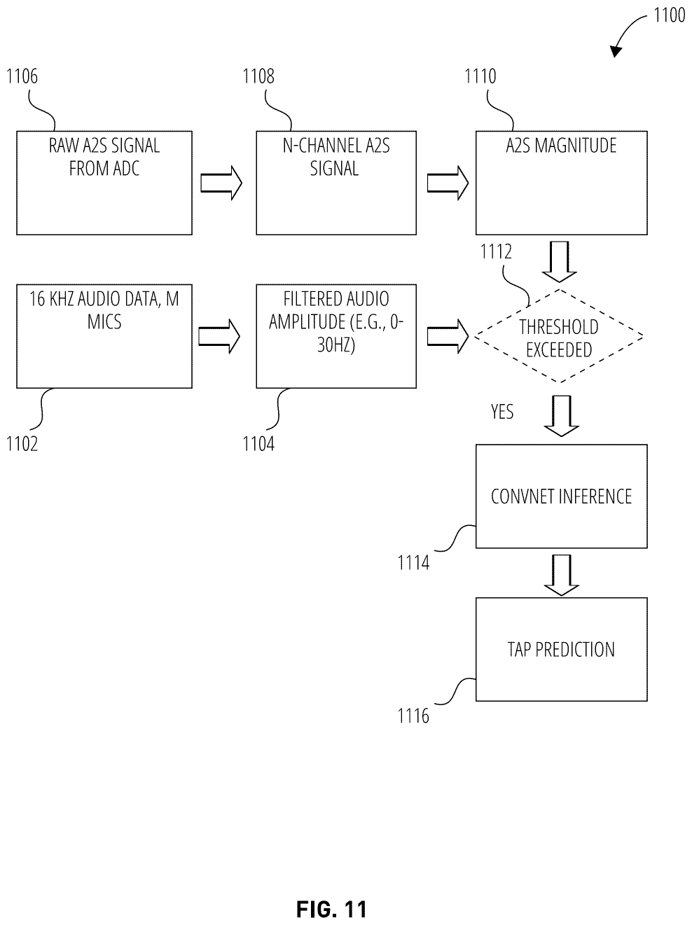

FIG. 11 is a flow diagram of high-level algorithm logic 1100 of tap classification logic 104 according to at least one embodiment. As described above, the raw A2S and microphone signals are preprocessed into a pair of signals (e.g., 25 Hz amplitudes representing A2S and audio excitations). In particular, the tap classification logic 104 receives audio data corresponding to audio captured by at least one microphone of a wireless device (block 1102). For example, the tap classification logic 104 can receive 16 kHz audio data from M microphones, where M is a positive integer equal to or greater than one. The tap classification logic 104 can preprocess the audio data to obtain a first waveform of amplitudes (block 1104). In at least one embodiment, the tap classification logic 104 can applying a 30-Hz low-pass digital filter to the audio data so that the first waveform is between 0 to 30 Hz. In at least one embodiment, the tap classification logic 104 can down-sample the audio data from a first sampling rate to a second sampling rate to obtain the first waveform at the second sampling rate. As described below the second sampling rate can corresponding to a sampling rate of the ADC. Although a 30-Hz high-pass filter is described above, in other embodiments, other high-pass filters can be used, such as 50-Hz or 60-Hz. Similarly, in other embodiments, other low-pass filters can be used other than 30-Hz.

The tap classification logic 104 receives impedance data (A2S signal) from an A2S system of the wireless device (block 1106). The impedance data is digital data representing impedance changes of an antenna captured by the A2S system. For example, the impedance data can be the raw A2S signals received from the ADC as described above. The tap classification logic 104 can preprocess the impedance data to obtain a second waveform of magnitudes at the second sampling rate (same sampling rate as the first waveform). In at least one embodiment, the tap classification logic 104 can preprocess the raw A2S signals by generating an N-channel A2S signal, where N is a positive integer equal to or greater than one (block 1108), and extracting peak values as a waveform of A2S magnitudes (block 1110). For example, the N-channel A2S signal can be a three-channel, quasi-continuous waveform and have three pulses caused by three advertisement packets sent in three channels. As described above, the tap classification logic 104 can apply a rolling minimum filter to each channel of the unfiltered N-channel A2S signal to get a smooth A2S baseline which is only modulated by antenna impedance changes caused by a nearby hand or object, as illustrated and described above with respect to FIG. 9.

In at least one embodiment, once the waveforms of audio amplitudes (i.e., preprocessed audio data) and A2S magnitudes (i.e., preprocessed impedance data) are obtained at block 1104 and block 1110, the tap classification logic 104 can determine, using the audio data and the impedance data and a machine learning (ML) model, a user input event representing a physical interaction event with the wireless device (block 1114). The user input event can be a tap prediction. The tap classification logic 104 can output the tap prediction (block 1116) and perform an action in response to the user input event (i.e., the tap prediction). In at least one embodiment, at block 1114, the ML model is a convolutional neural network that performs an inference.

In at least one embodiment, before inputting the waveforms into the ML model, some thresholding logic can be applied at block 1112, such as illustrated in FIG. 11. For example, the preprocessed pair of signals (e.g., 25 Hz amplitudes/magnitudes representing A2S and audio excitations) can be continuously monitored with a threshold detection logic at block 1112. When both the A2S signal and audio signal exceed pre-set thresholds within a certain time window, a region-of-interest (ROI) is determined and further analyzed via the convolutional neural network (or other ML model). In at least one embodiment, the tap classification logic 104 determines whether the first waveform exceeds a first threshold and the second waveform exceeds a second threshold within a certain time window. The tap classification logic 104 can determine a ROI in the first waveform and the second waveform for inputs to the ML model, responsive to the first waveform exceeding the first threshold and the second waveform exceeding the second threshold within the certain time window.

In at least one embodiment, a convolutional neural network can be trained to predict whether a given segment (also referred to herein as “time window”) of A2S and audio data corresponds to a tap or a non-tap. For example, each input segment can include 18 samples of 25-Hz A2S and audio data (i.e., an 18×2 tensor), where the candidate segment is extracted from continuous A2S and audio data based on amplitude criteria for each signal. For training, data can be collected containing both positive results (intentional taps) and negative results (non-taps). To generate negative training data, actions that induce signals from both modalities can be performed so as to exceed the amplitude thresholds and trigger neural network inference. For example, the actions can include hovering hands nearby the wireless device while playing music at max volume or placing various objects nearby the speaker. It should be noted that specific parameters, such as the number of A2S signal channels, number of available mics, length of input segment, and cut-off frequency for audio filter may vary from product to product.

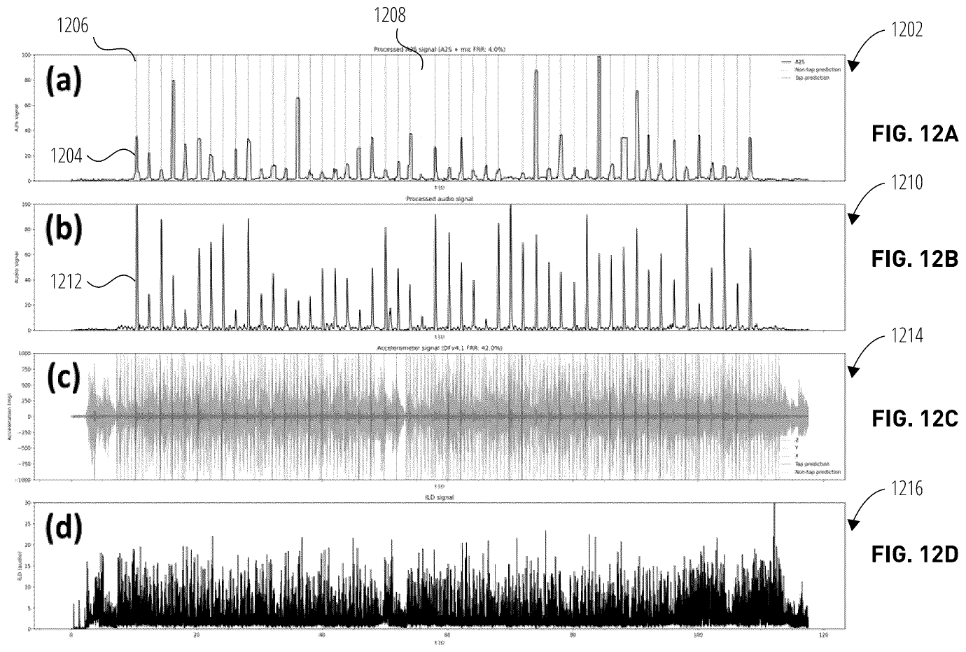

Embodiments of the ML model (also referred to as tap detection model) based on A2S and audio data can improve sensitivity as compared to tap detection models based on accelerometer and microphone fusion, as illustrated in graphs of FIG. 12A thru FIG. 12D. In particular, the tap detection models based on A2S and microphone data is robust to situations that challenge the accelerometer and microphone approach, such as placing the wireless device on wobbly furniture or tapping in the presence of loud music. For the data in graphs of FIG. 12A thru FIG. 12D, a user tapped fifty times on a wireless device while playing music at maximum volume.

FIG. 12A is a graph 1202 illustrating a preprocessed A2S signal 1204 for fifty taps, according to at least one embodiment. The vertical lines indicate either tap predictions 1206 or non-tap predictions 1208 from the A2S and audio algorithm of the tap classification logic 104.

FIG. 12B is a graph 1210 illustrating a preprocessed audio signal 1212 for the same fifty taps, according to at least one embodiment.

FIG. 12C is a graph 1214 illustrating a raw accelerometer signal along with tap and non-tap predictions for the accelerometer and audio fusion algorithm according to at least one implementation.

FIG. 12D is a graph 1216 illustrating ILD audio feature data for the accelerometer and audio fusion algorithm according to at least one implementation.

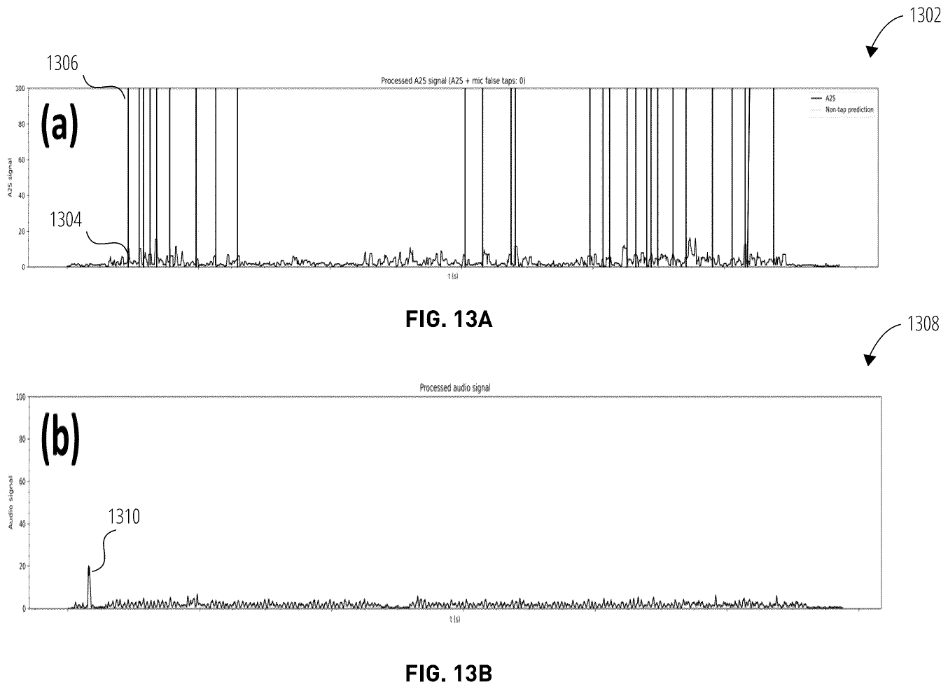

A comparison of graphs 1202 and 1210 of FIG. 12A and FIG. 12B against the graphs 1214 and graph 1216 of FIG. 12C and FIG. 12D, highlights the improvement in tap visibility using A2S and audio data with the signal processing techniques described herein as compared to the approaches using accelerometer data and audio features. Additionally, an end-to-end ML model (e.g., convolution neural network) can correctly predicts taps at a much higher rate using A2S and microphone fusion as compared to accelerometer and microphone fusion. For example, a false rejection rate (FRR), which represents the fraction of taps missed by the algorithm) is only 4% for A2S and microphone fusion vs. 42% for accelerometer and microphone fusion in this data. At the same time, the end-to-end ML model can correctly reject false taps despite hovering/waving hands near the surface of the wireless device in the presence of max-volume music playback, such as illustrated in FIG. 13A and FIG. 13B.

FIG. 13A is a graph 1302 illustrating a preprocessed A2S signal 1304 for non-tap activity, according to at least one embodiment. The non-tap activity can include waving or swiping hands near the surface of the wireless device while playing music at maximum volume. The vertical lines indicate non-tap event predictions 1306 from the A2S and audio algorithm of the tap classification logic 104.

FIG. 13B is a graph 1308 illustrating a preprocessed audio signal 1310 for the same non-tap activity, according to at least one embodiment.

Despite significant A2S signal (FIG. 13A) and audio signals (FIG. 13B) which cross the thresholds and trigger neural network inference, the tap detection model correctly recognizes the excitations as non-tap event predictions 1306, illustrated as vertical lines in FIG. 13A.

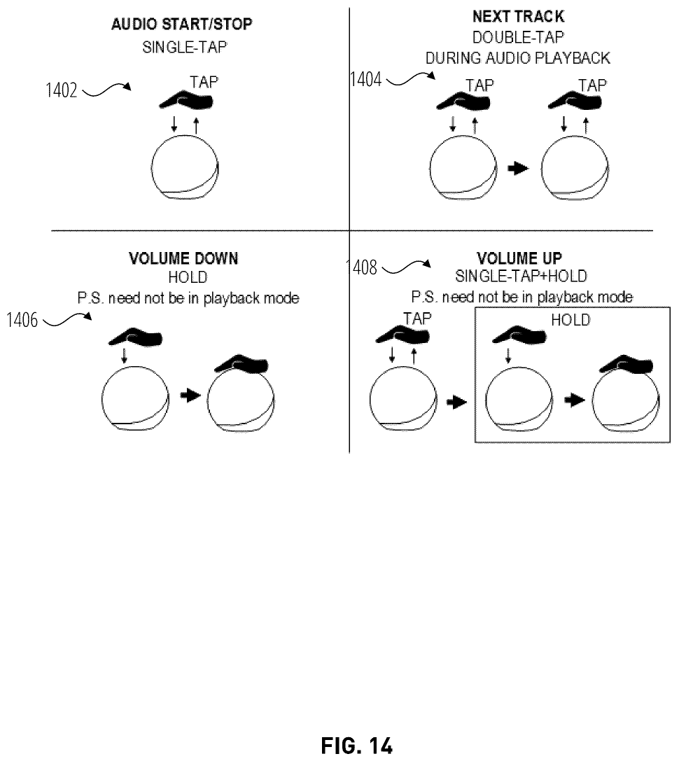

FIG. 14 illustrates multiple gestures and corresponding actions according to at least one embodiment. A single tap gesture 1402 involves a user momentarily placing their hand over a wireless device and removing their hand within a specified amount of time. As a result of detecting the single tap gesture 1402, the wireless device can start or stop audio playback during an audio playback mode. A double-tap gesture 1404 involves the user momentarily placing their hand over a wireless device, removing their hand within a specified amount of time, momentarily placing their hand over the wireless device again within a specified amount of time, and removing their hand within a specified amount of time. As a result of detecting the double-tap gesture 1404, the wireless device can skip to a next track during an audio playback mode. A hold gesture 1406 involves a user placing their hand over a wireless device and keeping their hand there for a specified amount of time. As a result of detecting the hold gesture 1406, the wireless device can decrease the volume. The volume can be decreased in the playback mode or in other modes. A tap and hold gesture 1408 involves a user momentarily placing their hand over a wireless device and removing their hand within a specified amount of time, placing their hand again over the wireless device and keeping their hand there for a specified amount of time. As a result of detecting the tap and hold gesture 1408, the wireless device can increase the volume. The volume can be increased in the playback mode or in other modes.

As described above, the tap classification logic 104 can detect simple single-touch gestures, such as a touch, tap, or double tap of the wireless device, as illustrated in FIG. 14. Normally multiple antennas and detection circuits would be needed to detect touches in multiple locations of the wireless device. However, as described herein, the tap classification logic 104 can also recognize multiple touches at different locations over time for additional touch events or gesture events, including swipe gestures, using the antenna 110 and the microphone 118.

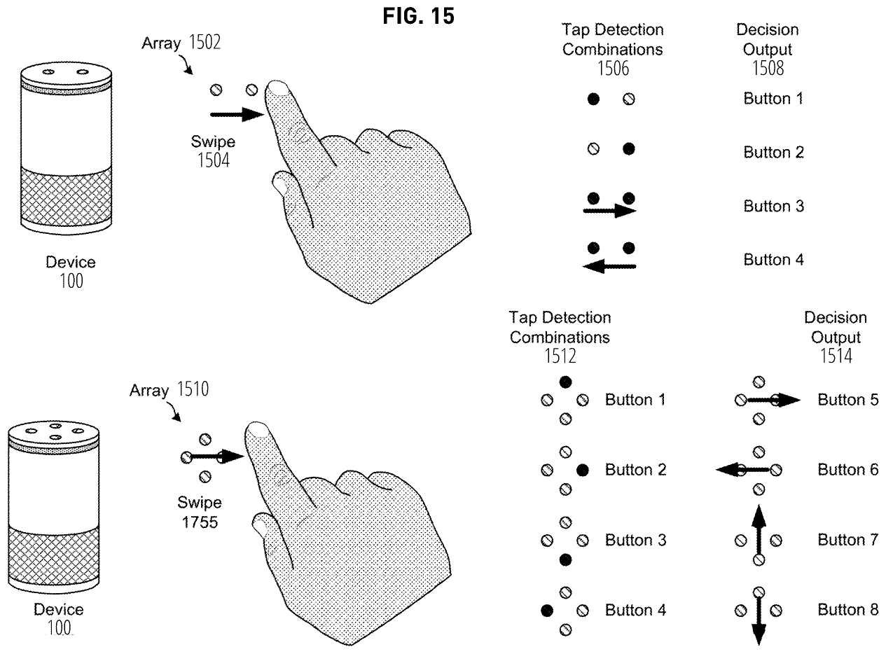

FIG. 15 illustrates examples of tap detection decisions according to embodiments of the present disclosure. As illustrated in FIG. 15, the wireless device 100 may include different microphone arrays having a different number of microphones and therefore the wireless device 100 may be configured to detect a varying number of virtual buttons by performing tap detection processing for each of the microphones.

In one examples, an array 1502 may include two microphones and the wireless device 100 may determine whether a tap event is detected at either microphone over time. Thus, the wireless device 100 may distinguish between a single tap event detected using the first microphone and a single tap event detected using the second microphone, treating the distinct tap events as separate buttons. Additionally or alternatively, the wireless device 100 may detect a first tap event using the first microphone followed by a second tap event using the second microphone, which corresponds to a swipe 1504 motion (e.g., user swipes from the first microphone to the second microphone).

As illustrated in FIG. 15, using the array 1502, the wireless device 100 may detect four tap detection combinations 1506 that correspond to four decision outputs 1508 (e.g., wireless device 100 may perform up to four separate actions). For example, a tap event at the first microphone corresponds to a first button press (e.g., Button 1), a tap event at the second microphone corresponds to a second button press (e.g., Button 2), a swipe from the first microphone to the second microphone corresponds to a third button press (e.g., Button 3), and a swipe from the second microphone to the first microphone corresponds to a fourth button press (e.g., Button 4).

In some examples, the wireless device 100 may include four microphones without departing from the disclosure, as illustrated by array 1510. As the array 1510 includes four separate microphones, the wireless device 100 may detect four separate tap events and up to four separate swipe events. As illustrated in FIG. 15, using the array 1510 the wireless device 100 may detect eight tap detection combinations 1512 that correspond to eight decision outputs 1514 (e.g., wireless device 100 may perform up to eight separate actions). For example, a tap event at the first microphone corresponds to a first button press (e.g., Button 1), a tap event at the second microphone corresponds to a second button press (e.g., Button 2), a tap event at the third microphone corresponds to a third button press (e.g., Button 3), a tap event at the fourth microphone corresponds to a fourth button press (e.g., Button 2), a swipe left-to-right (e.g., from the fourth microphone to the second microphone) corresponds to a fifth button press (e.g., Button 5), a swipe right-to-left (e.g., from the second microphone to the fourth microphone) corresponds to a sixth button press (e.g., Button 6), a swipe bottom-to-top (e.g., from the third microphone to the first microphone) corresponds to a seventh button press (e.g., Button 7), and a swipe top-to-bottom (e.g., from the first microphone to the third microphone) corresponds to an eighth button press (e.g., Button 8).

While FIG. 15 illustrates the wireless device 100 detecting a single tap event, the disclosure is not limited thereto and the wireless device 100 may distinguish between multiple tap events within a short period of time. For example, the wireless device 100 may perform a first action when a single tap event is detected and may perform a second action when a double tap event is detected. Additionally or alternatively, the wireless device 100 may distinguish between triple tap events and/or the like without departing from the disclosure.

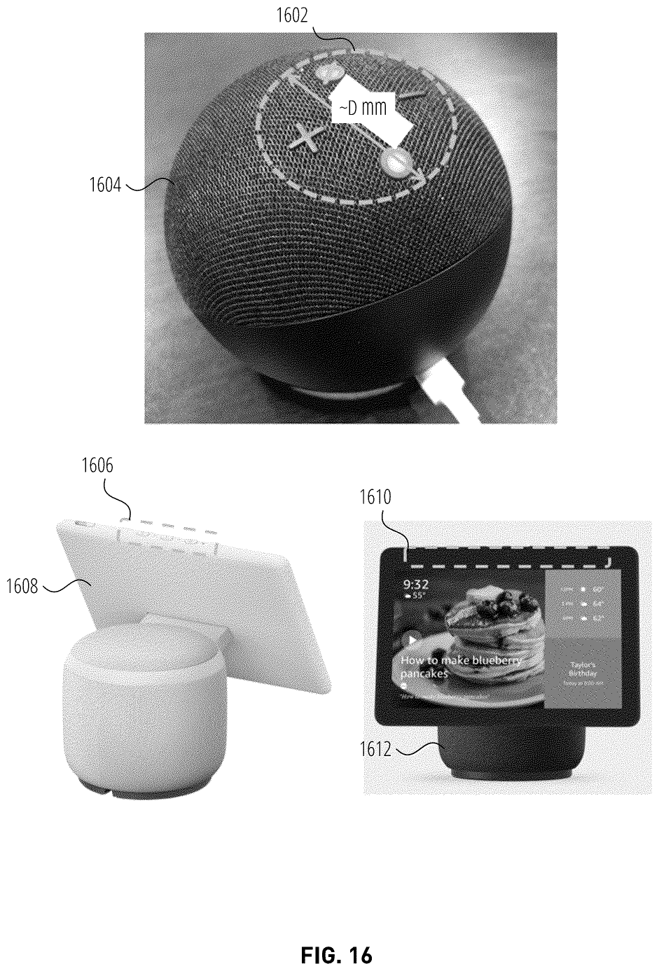

FIG. 16 show a few examples of ergonomically suitable areas for placement of an antenna according to various embodiment. In at least one embodiment, the antenna can be located right under an inner layer of an external housing in a first area 1602 of a first wireless device 1604. The first area 1602 can be located at a top of a dome of the first wireless device 1604. The antenna can replace one or more capacitive or mechanical push buttons that would otherwise be located in the first area 1602.

In at least one embodiment, the antenna can be located right under an inner layer of an external housing in a second area 1606 of a second wireless device 1608. The second area 1606 can be located in a top edge of a display of the second wireless device 1608. The antenna can replace one or more capacitive or mechanical push buttons that would otherwise be located in the second area 1606.

In at least one embodiment, the antenna can be located behind a glass at a top portion in a third area 1610 of a third wireless device 1612. Alternatively, the antenna can be located behind a glass on a side portion of the screen (not labeled in FIG. 16). The third area 1610 can be located in the top outer rim of the display to enable smooth touch/swipe gestures as if part of the display.

It should be noted that the conceptualization of an antenna can start with considering certain design requirements, such as the following:
1. how many unique gesture detection is required? and in turn how many virtual touch buttons are required (N) to achieve those gestures?
2. What is the preferred layout of the virtual buttons on the device surface that will give best customer experience while performing different gestures? This will in turn define the required physical extent of the antenna aperture, which is also primarily depends on the operating frequency. The higher the frequency the smaller the antenna footprint.
3. Considering average human fingertip size varying in the range ˜10-15 mm diameter, any two neighboring virtual buttons should have adequate physical separation from each other to minimize overlap of their touch sensitive regions.

For example, the first area 1602 of the first wireless device 1604 can have a specified diameter of D (e.g., 50 mm) where normally four capacitive push buttons are located in a diamond shape, namely Mute, Volume Up, Action, Volume Down. The antenna can be located in this same area and have three or four virtual buttons defined. The housing can have labels that identify where the user should touch for the respective action items.

In at least one embodiment, an electronic device includes an antenna, a detection circuit coupled to the antenna, a microphone, and a wireless radio coupled to the antenna. The electronic device also includes one or more processors and one or more computer readable media storing processor executable instructions which, when executed using the one or more processors, cause the electronic device to perform operations including: receiving audio data corresponding to audio captured by at least one microphone of the device; receiving impedance data from the A2S system of the device, the impedance data is digital data representing impedance changes of an antenna captured by the A2S system; determining, using the audio data and the impedance data and a machine learning model, a user input event representing a physical interaction event with the device; and performing an action in response to the user input event.

In a further embodiment, the one or more computer readable media store processor executable instructions which, when executed using the one or more processors, cause the electronic device to perform operations further including: preprocessing the impedance data to obtain a first waveform of magnitudes at a first sampling rate; preprocessing the audio data to obtain a second waveform of amplitudes at the first sampling rate; determining whether the first waveform exceeds a first threshold and the second waveform exceeds a second threshold within a certain time window; and determining a region of interest (ROI) in the first waveform and the second waveform for inputs to the ML model, responsive to the first waveform exceeding the first threshold and the second waveform exceeding the second threshold within the certain time window. In at least one embodiment, the first sampling rate is approximately 25 Hz. Alternatively, other sampling rates may be used.

In at least one embodiment, the electronic device includes an analog-to-digital converter coupled to the A2S system. In at least one embodiment, the ADC can receive an analog voltage signal from the detection circuit and sample the analog voltage signal at a first sampling rate to obtain the impedance data representing the impedance changes of the antenna. The operation of determining of the first voltage value and the determining of the second voltage value utilizes the analog-to-digital converter. In at least one embodiment, the first voltage value is a value that was sampled using the analog-to-digital converter from a signal received from the detection circuit.

In at least one embodiment, the operations further include: identifying a sequential pattern of pulses and extracting a peak value of each pulse, the sequential pattern of pulses corresponding to a plurality of advertisement packets over the antenna over a plurality of channels during a first time window; and generating, using the peak values, a multi-channel waveform representing the impedance changes of the antenna in the plurality of channels during the first time window, wherein the multi-channel waveform is the first waveform input into the ML model.

In at least one embodiment, the operations further include: applying a 30-Hz low-pass digital filter to the audio data; and down-sampling the audio data from a second sampling rate to the first sampling rate to obtain the second waveform at the first sampling rate.

In at least one embodiment, the operations further include: transmitting a plurality of advertisement packets over the antenna over a plurality of channels during a first time window;
measuring and converting, by a detection circuit of the A2S system, the impedance changes of the antenna into an analog voltage signal; and converting the analog voltage signal, by an analog-to-digital converter (ADC) of the A2S, into the impedance data corresponding to the first time window.

In at least one embodiment, the ML model is a convolutional neural network. In at least one embodiment, the determining the user input event includes predicting, using the convolution neural network, whether a segment of the audio data and a corresponding segment of the impedance data corresponds to the user input event representing the physical interaction event with the device.

In at least one embodiment, the user input event is at least one of a tap event, a single-touch event corresponding to a user touch of the device, a multi-touch event corresponding to multiple simultaneous user touches of the device, a swipe event involving a user touch or user touches of the device, or a gesture event involving a user touch or user touches of the device.

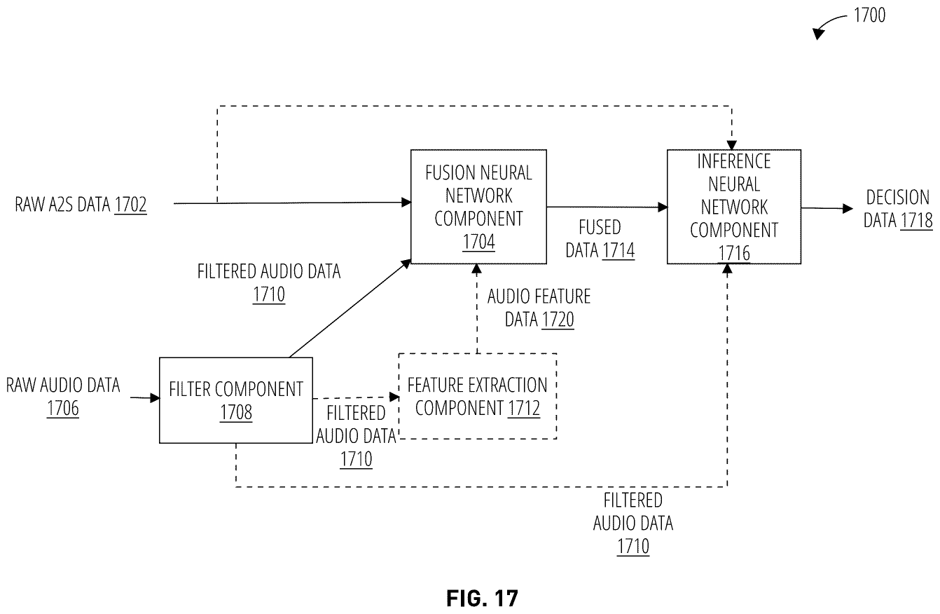

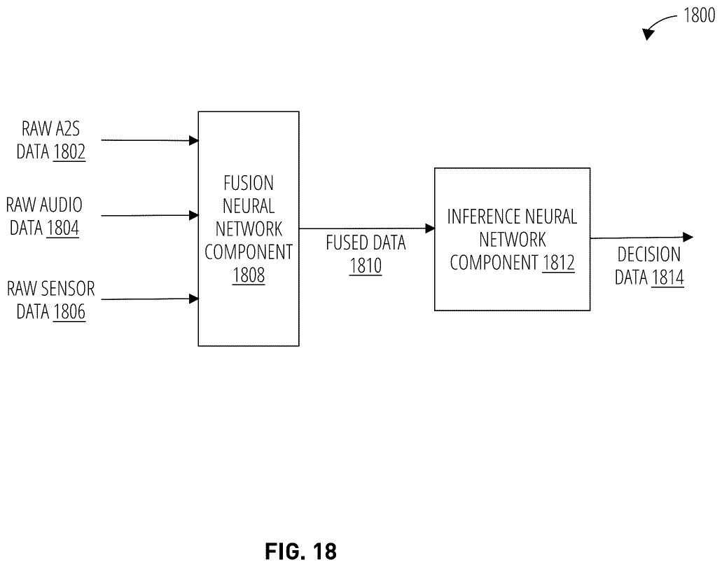

FIG. 17 to FIG. 18 illustrate example component diagrams for a tap detection pipeline and an event detection pipeline according to embodiments of the present disclosure. As described above, the wireless device 100 may perform event detection using a combination of microphone audio data and A2S data, such as A2S data generated by a A2S system (e.g., A2S). In some examples, the wireless device 100 may generate fused data by processing audio features and the A2S data, as illustrated in FIG. 17. In other examples, the wireless device 100 may generate the fused data by processing raw audio data, raw A2S data, and/or additional A2S data, as illustrated in FIG. 18. However, the disclosure is not limited thereto, and the wireless device 100 may generate the fused data using raw audio data, raw A2S data, processed audio data, processed A2S data, feature data derived from any of the abovementioned data, and/or a combination thereof without departing from the disclosure. Depending on the inputs, a number of branches, a branch depth, and/or a number of event detectors may vary without departing from the disclosure.

As illustrated in FIG. 17, a tap detection pipeline 1700 may include components configured to perform a variety of processing to enable tap detection. For example, some of the components may perform feature extraction to generate features associated with the input data, fusion processing to combine the features and generate fused data, and/or event detection to detect an event using the fused data. In some examples, the tap detection pipeline 1700 may perform feature extraction prior to performing fusion processing. For example, FIG. 17 illustrates an example in which the tap detection pipeline 1700 includes a filter component 1708 and an optional feature extraction component 1712 configured to generate audio feature data 1720. However, the disclosure is not limited thereto, and the tap detection pipeline 1700 may perform fusion processing without these components without departing form the disclosure.

In some examples, raw A2S data 1702 may be sampled at a first sampling rate (e.g., 25 Hz) and can be represented as a sequence of values as follows:

$$[ ( a 2 s [ 1 ] ) , ( a 2 s [ 2 ] ) … ] \qquad [ 1 ]$$

where A2S[i] denote A2S data at i-th time index, respectively. Similarly, raw audio data 1706 from M microphones may be sampled at a second sampling rate (e.g., 16 kHz) and can be represented at discrete time index j as follows:

$${x}_{m} [ j ] , m = 1 , … , M \qquad [ 2 ]$$

While the second sampling rate of the raw audio data 1706 is higher compared to the first sampling rate of the raw A2S data 1702, in some examples the feature extraction component 1712 may reduce the dimensionality of the audio signal via filtering and windowed root-mean-squared (RMS) averaging, although the disclosure is not limited thereto. In at least one embodiment, the feature extraction component 1712 can down-sample the raw audio data 1706 down to the same sampling rate as the raw A2S data 1702 (e.g., 25 Hz).

As illustrated in FIG. 17, the filter component 1708 may receive the raw audio data 1706 corresponding to M microphones 118 and may perform low-pass filtering (or bandpass filtering) to generate filtered audio data 1710. As taps are physical impulses exciting mechanical modes of the structure of the wireless device 100, their energy can be isolated from irrelevant acoustic events (e.g., voices, music, etc.) via spectral filtering in the low-frequency band. For example, the filter component 1708 may perform bandpass filtering using a first cutoff frequency (e.g., 20 Hz) and a second cutoff frequency (e.g., 720 Hz) in order to pass frequency bands within a first frequency range (e.g., 20 Hz-720 Hz, although the disclosure is not limited thereto) and attenuate frequency bands outside the first frequency range. For another example, the filter component 1708 may perform low-pass filtering using a cutoff frequency (e.g., 30 Hz) in order to pass frequency bands lower than the cutoff frequency (e.g., 30 Hz).

The filter component 1708 may output the filtered audio data 1710 to the feature extraction component 1712, which may process the filtered audio data 1710 to extract audio feature data 1720. For example, the feature extraction component 1712 may determine RMS amplitude values in non-overlapping windows of N samples each, where N denotes a number of microphone samples per audio feature sample, x̅ₘ(t) are the band-pass-filtered microphone signals (e.g., filtered audio data 1710) for the M microphones 118, and I_{M} is the maximum value of integer possible for a given bit-precision of the band-pass-filtered microphone signals. The second sampling rate (e.g., 16 kHz) associated with the filtered audio data 1710 may be reduced to the first sampling rate (e.g., 25 Hz) associated with raw A2S data 1702 based on the number of microphone samples N (e.g., N=40). Thus, the RMS amplitude values Rₘ[i] may share the second sampling rate (e.g., 300 Hz) with the raw A2S data 1702, although the disclosure is not limited thereto.

Using the RMS amplitude values Rₘ[i], the feature extraction component 1712 may generate the audio feature data 1720 by determining two metrics (e.g., two audio features). For example, the feature extraction component 1712 may determine average RMS values R[i] and inter-channel level difference (ILD) values ILD[i]. However, the disclosure is not limited thereto and the wireless device 100 may generate the audio feature data 1720 using other techniques without departing from the disclosure.

The feature extraction component 1712 may calculate the average RMS values R[i] as a mean of the RMS amplitude values Rₘ[i] over all microphone channels. While the RMS amplitude values Rₘ[i] may be measured in decibels relative to full scale (dBFS), the average RMS values R[i] may be measured in decibels (dB). As the microphones 118 may be closely spaced at a top of the wireless device 100, the average RMS values R[i] may be large when a user taps at the top of the wireless device 100.

The feature extraction component 1712 may determine the ILD values ILD[i] by subtracting the quietest microphone channel from a loudest microphone channel, at each time step i, and scaling the difference by an attenuation function, where denotes an attenuation function to control an attenuation of the ILD values ILD[i]. In some examples, the wireless device 100 may select a first parameter value (e.g.,) and a second parameter value (e.g.,) to ensure that the ILD value ILD[i] is low when the overall average RMS value R[i] is low, reducing the impact of noisy fluctuations on the ILD values ILD[i] in the absence of a strong microphone signal. A tap event, however, inadvertently happens closer to one microphone than the others, resulting in a high ILD value ILD[i].

In some examples the wireless device 100 may perform region-of-interest (ROI) detection prior to performing sensor fusion and tap detection. For example, the wireless device 100 may preprocess the raw A2S data 1702 and the audio feature data 1720 to detect an ROI that satisfies a condition. Thus, the wireless device 100 only performs sensor fusion and/or tap detection when an individual ROI satisfies the condition, ignoring input signals that do not satisfy the condition as non-tap events.

In some examples, the wireless device 100 may associate a first number of samples of the input data (e.g., 100 samples) with each individual ROI on which to perform event detection. To illustrate an example, the wireless device 100 may continuously buffer the raw A2S samples and the audio features (e.g., average RMS values R[i] and ILD values ILD[i]) using a first window (e.g., 0.5s window). Thus, the ROI on which to perform event detection may consist of 200 values for each of the features (e.g., A2S[i], R[i], and ILD[i] for). However, the disclosure is not limited thereto and the number of samples associated with each ROI may vary without departing from the disclosure.

In some examples, the wireless device 100 may send the ROI (e.g., portion of fused data 1714) to an inference neural network component 1716 for event detection if and only if the raw A2S data exceeds a minimum threshold (Y_{TH}) for a candidate tap (e.g., A2S[i]>Y_{TH} for at least one time index i). Otherwise, the wireless device 100 may reject the ROI as a non-tap event without processing the fused data 1714 using the inference neural network component 1716. Thus, the wireless device 100 may monitor the A2S data and send an ROI of 100 samples before and after the index i at which the A2S data A2S[i] crosses the threshold Y_{TH}. Additionally or alternatively, the wireless device 100 may skip performing ROI detection without departing from the disclosure. For example, the inference neural network component 1716 may continuously process the fused data 1714 without requiring a candidate ROI to first satisfy the condition.

In some examples, the wireless device 100 may send the ROI (e.g., portion of fused data 1714) to an inference neural network component 1716 for event detection if and only if the raw A2S data exceeds a minimum threshold (Y_{T}H), and the audio data exceeds a minimum threshold (Z_{TH}) (e.g., A2S[i]>Y_{TH} and xₘ[j]>Z_{TH}) for at least one time index i) and j). Otherwise, the wireless device 100 may reject the ROI as a non-tap event without processing the fused data 1714 using the inference neural network component 1716. Thus, the wireless device 100 may monitor the A2S data and audio data and send an ROI of 100 samples before and after the index i at which the A2S data A2S[i] crosses the threshold Y_{TH} and 100 samples before and after the index j at which the audio data xₘ[j] crosses the threshold Z_{TH}. Additionally or alternatively, the wireless device 100 may skip performing ROI detection without departing from the disclosure. For example, the inference neural network component 1716 may continuously process the fused data 1714 without requiring a candidate ROI to first satisfy the condition.

If the wireless device 100 determines that the ROI satisfies the condition and/or the wireless device 100 skips performing ROI detection, a fusion neural network component 1704 may process the raw A2S data 1702 and the audio feature data 1720 to generate fused data 1714. The first fusion neural network component 1704 may use separate neural networks to independently process (e.g., extract features from) the raw A2S data 1702 and the audio feature data 1720 prior to generating fused data 1714. For example, the fusion neural network component 1704 may apply a first filter to the raw A2S data 1702 (e.g., process using a first neural network, such as a first set of convolutional layers) in order to generate A2S features, may apply a second filter to the audio feature data 1720 (e.g., process using a second neural network, such as a second set of convolutional layers) to generate processed audio features, and then may concatenate the A2S features and the processed audio features to generate the fused data 1714. This multi-branch approach improves an accuracy of tap detection and enables detection of additional tap gestures and/or other types of event/activity detection (e.g., typing detection). After generating the fused data 1714, the fusion neural network component 1704 may output the fused data 1714 to the inference neural network component 1716. In another embodiment, the tap detection pipeline 1700 can include a feature extraction component that receives the raw A2S data 1702 and generates A2S feature data that is provided to the fusion neural network component 1704.

As illustrated in FIG. 17, the inference neural network component 1716 may be configured to perform event detection by processing the fused data 1714. For example, the inference neural network component 1716 may include task-specific inference layers configured to generate decision data 1718 indicating whether the event was detected in the fused data 1714 (e.g., whether the ROI corresponds to a tap event). The inference neural network component 1716 may apply a third filter to the fused data 1714 (e.g., process using a third neural network, such as a third set of convolutional layers) in order to generate inference data and may process the inference data using an output layer (e.g., classification layer, dense layer, regression layer, etc.) to generate the decision data 1718.

While FIG. 17 only illustrates a single inference neural network component 1716, the disclosure is not limited thereto and the tap detection pipeline 1700 may include multiple inference neural network components 1716 without departing from the disclosure. Additionally or alternatively, the inference neural network component 1716 may include multiple task-specific inference layers, enabling a single inference neural network component 1716 to detect multiple tap events, gestures, typing events, and/or the like based on the fused data 1714.

While FIG. 17 to FIG. 18 illustrate the fusion neural network component 1704 separately from the inference neural network component 1716, this is intended to conceptually illustrate an example and the disclosure is not limited thereto. Instead, the fusion neural network component 1704 may correspond to a first portion of a neural network while the inference neural network component 1716 may refer to a second portion of the neural network without departing from the disclosure. While the inference neural network component 1716 is described with reference to generating inference data, the disclosure is not limited thereto and the inference neural network component 1716 may perform feature refinement (e.g., generate features based on features represented in the fused data 1714/1810), inference, and/or additional processing without departing from the disclosure.

The fusion neural network component 1704 (e.g., first portion of the neural network) may include multiple branches, with a unique branch for each modality (e.g., type of sensor input). Thus, the fusion neural network component 1704 may separately process each type of sensor input to extract features and generate feature data. As part of performing a fusion operation to generate the fused data 1714/1810, the fusion neural network component 1704 may align the feature data between the multiple branches, such that the feature data shares the same time steps (e.g., fixed sample rate). Thus, the latent space has the same dimensionality across the feature data, regardless of a number of channels. In some examples, the fusion neural network component 1704 may generate the fused data 1714/1810 by concatenating the feature data from each of the multiple branches, although the disclosure is not limited thereto and the fusion neural network component 1704 may generate the fused data 1714/1810 using other techniques without departing from the disclosure.

In some examples, the fused data may include a first number of samples (e.g., 100 samples) and a second number of channels, which may vary depending on the number of branches and/or types of sensor input. For example, the fused data 1714 may include three channels corresponding to the raw A2S data 1702 and two channels corresponding to the audio feature data 1720, such that the fused data 1714 has first dimensions (e.g., 100 samples×5 channels). Additionally or alternatively, the fused data 1810 may include three channels corresponding to the raw A2S data 1702 and ten channels corresponding to the raw audio data 1706, such that the fused data 1810 has second dimensions (e.g., 100 samples×13 channels). However, the disclosure is not limited thereto and the first number of samples and/or the second number of channels may vary without departing from the disclosure.

As used herein, the fusion neural network component 1704 may correspond to a trained model, such as a machine learning model, neural network, convolutional neural network (CNN), deep neural network (DNN), transformer network, multilayer perceptron (MLP) network (e.g., fully connected network), feedforward artificial neural network, other architecture, and/or a combination thereof. In some examples, the fusion neural network component 1704 may include multiple sensor-specific feature extraction branches, and each feature extraction branch may comprise similar architecture and/or different architecture without departing from the disclosure. For example, a first feature extraction branch may correspond to a CNN, while a second feature extraction branch may correspond to a transformer network, although the disclosure is not limited thereto. Additionally or alternatively, multiple feature extraction branches may use the same type of architecture (e.g., CNN, transformer network, etc.) but a number of layers, type of layers, and/or the like may vary without departing from the disclosure.

The inference neural network component 1716 (e.g., second portion of the neural network) may include multiple task-specific branches, with a unique branch for each decision output (e.g., type of decision). Thus, the inference neural network component 1716 may separately process the fused data 1714/1810 to generate two or more decision outputs without departing from the disclosure.

In some examples, the inference neural network component 1716 may be configured to perform event detection classification. For example, the inference neural network component 1716 may include a predictive layer (e.g., classification layer) configured to select between discrete classification categories and/or determine whether an event is detected. However, the disclosure is not limited thereto, and the inference neural network component 1716 may be configured to perform classification, regression, prediction, generation, other processing, and/or a combination thereof without departing from the disclosure. For example, a first task-specific inference branch may be configured to perform classification, while a second task-specific inference branch may be configured to perform a combination of classification and regression without departing from the disclosure.

As used herein, the inference neural network component 1716 may correspond to a trained model, such as a machine learning model, neural network, CNN, DNN, transformer network, MLP network, feedforward artificial neural network, other architecture, and/or a combination thereof. In some examples, the inference neural network component 1716 may include multiple task-specific inference branches, with each branch comprising similar architecture and/or different architecture without departing from the disclosure. For example, a first task-specific inference branch may correspond to a CNN, while a second task-specific inference branch may process the same fused data 1714/1810 but correspond to a transformer network, although the disclosure is not limited thereto. Additionally or alternatively, multiple task-specific inference branches may use the same type of architecture (e.g., CNN, transformer network, etc.) but a number of layers, type of layers, type of predictive layer (e.g., output layer), and/or the like may vary without departing from the disclosure.

While the tap detection pipeline 1700 illustrated in FIG. 17 includes feature extraction components (e.g., filter component 1708 and feature extraction component 1712) prior to the first fusion neural network component 1704, such that the fusion neural network component 1704 receives the audio features (e.g., average RMS values R[i] and ILD values ILD[i]) as inputs, the disclosure is not limited thereto. As described above, the wireless device 100 may generate the fused data 1714 by processing the raw A2S data, the raw audio data, and/or additional A2S data without departing from the disclosure.

FIG. 18 illustrates an example of an event detection pipeline 1800 configured to perform event detection. In the event detection pipeline 1800, the inference neural network component 1812 may perform event detection by processing fused data 1810 to generate decision data 1814. As the inference neural network component 1716 was previously described above with regard to FIG. 17, a redundant description is omitted.

As illustrated in FIG. 18, the feature extraction components (e.g., filter component 1708 and feature extraction component 1712) are not included in the event detection pipeline 1800. Instead, a fusion neural network component 1808 may receive the raw A2S data 1802 and the raw audio data 1804 prior to feature extraction. Additionally or alternatively, the fusion neural network component 1808 may receive additional sensor inputs, such as raw sensor data 1806, illustrated in FIG. 18. While the raw A2S data 1802 is illustrated as a single input, the disclosure is not limited thereto and the fusion neural network component 1808 may receive separate raw A2S data 1802 from two or more sensor components of the wireless device 100 without departing from the disclosure.

In some examples, the fusion neural network component 1808 may receive the raw A2S data 1802 and the raw audio data 1804, described in greater detail above with regard to FIG. 17, and may generate fused data 1810 using only these two inputs. In other examples, the fusion neural network component 1808 may receive the raw A2S data 1802, the raw audio data 1804, and the raw sensor data 1806 associated with one or more sensors and may generate the fused data 1810 using these inputs. However, the disclosure is not limited thereto and the fusion neural network component 1808 may generate the fused data 1810 based on the raw A2S data 1802, the raw audio data 1804, the raw sensor data 1806, and/or a combination thereof without departing from the disclosure. For example, the fusion neural network component 1808 may generate the fused data 1810 using the raw audio data 1804 and the raw A2S data 1802, but not the raw sensor data 1806, without departing from the disclosure.

Additionally or alternatively, the fusion neural network component 1808 may receive features extracted from any of the raw A2S data 1802, the raw audio data 1804, and/or the raw sensor data 1806 without departing from the disclosure. Thus, while the event detection pipeline 1800 does not include the feature extraction components illustrated in FIG. 17, the disclosure is not limited thereto and the fusion neural network component 1808 may generate the fused data 1810 using the raw A2S data 1802, the raw audio data 1804, and the raw sensor data 1806 without departing from the disclosure.

While the fusion neural network component 1808 may be configured to process a number of different inputs, the fusion neural network component 1808 may include a separate neural network branch for each unique input (e.g., discrete branch per modality). Thus, the fusion neural network component 1808 may include distinct branches configured to extract features from different sensing modalities. For example, the fusion neural network component 1808 may include sensing-modality-specific feature extraction layers, enabling the fusion neural network component 1808 to extract features independently for each input before generating the fused data 1810.

Depending on the inputs, a number of branches, a branch depth, and/or a number of event detectors may vary without departing from the disclosure. For example, two input branches can uniform depths, two input branches different branch depths, three or more branches with uniform or different branch depths, or varying a number of event detectors (e.g., performing task-specific processing using the shared fused data 1810).

As described above with regard to FIG. 17, in some examples the wireless device 100 may associate a first number of samples of the input data (e.g., 200 samples) with each individual ROI on which to perform event detection. For example, the wireless device 100 may continuously buffer the raw A2S samples and the audio features (e.g., average RMS values R[i] and ILD values ILD[i]), such that the ROI on which to perform event detection may consist of 200 values for each of the features (e.g., A2S[i], R[i], and ILD[i] for i∈{1, . . . , 200}). Thus, the raw A2S data 1702 may correspond to three channels of the first number of samples, such that A2S channels have first dimensions (e.g., 1×200×3 input), while the audio feature data 1720 may correspond to two channels of the first number of samples, such that audio channels have second dimensions (e.g., 1×200×2 input).

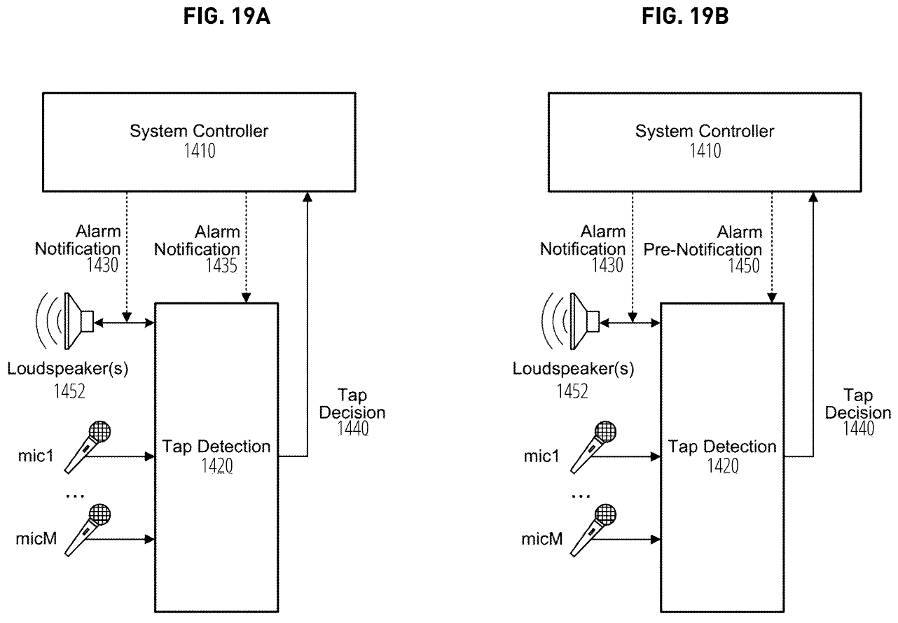

FIG. 19A to FIG. 19B illustrate examples of performing tap detection during alarm notifications according to embodiments of the present disclosure. As illustrated in FIG. 19A, the wireless device 100 may include a system controller component 1410 that coordinates with a tap detection component 1420 during an alarm event. For example, the system controller component 1410 may send an alarm notification 1430 to the loudspeaker(s) 1452 (e.g., output audio corresponding to the alarm event) and may also send an alarm notification 1435 to the tap detection component 1420, notifying the tap detection component 1420 that the alarm is currently being generated. The tap detection component 1420 may begin tap detection processing upon receipt of the alarm notification 1435, sending a tap decision 1440 to the system controller component 1410. Thus, if the tap detection 1420 detects a tap event, the tap detection component 1420 may send the tap decision 1440 indicating that the tap event was detected and the system controller component 1410 can disable or snooze the alarm event (e.g., cease outputting the output audio corresponding to alarm playback).

In some examples, the system controller component 1410 may send an alarm pre-notification 1450 prior to the system controller component 1410 sending the alarm notification 1430 to the loudspeaker(s) 1452, as illustrated in FIG. 19B. For example, a fixed time (e.g., 10 seconds) prior to the scheduled alarm notification 1430, the system controller component 1410 may send the alarm pre-notification 1450 to the tap detection component 1420. The tap detection component 1420 may perform tap detection processing to monitor the ILD values and, if the tap detection component 1420 detects a tap event prior to the scheduled alarm notification 1430, the tap detection component 1420 may determine that wind conditions are present and set an ILD threshold value to the wind threshold value (e.g., 30 dB).

While not illustrated in FIG. 19B, in some examples the wireless device 100 may receive an indication that a button press occurred to ignore tap event detection. For example, the wireless device 100 may receive a button press input on a physical button, separate from a tap event on a microphone. The wireless device 100 may detect the button press input and send a notification to the tap detection component 1420 to ignore the tap event or to disable tap event processing for a period of time without departing from the disclosure.

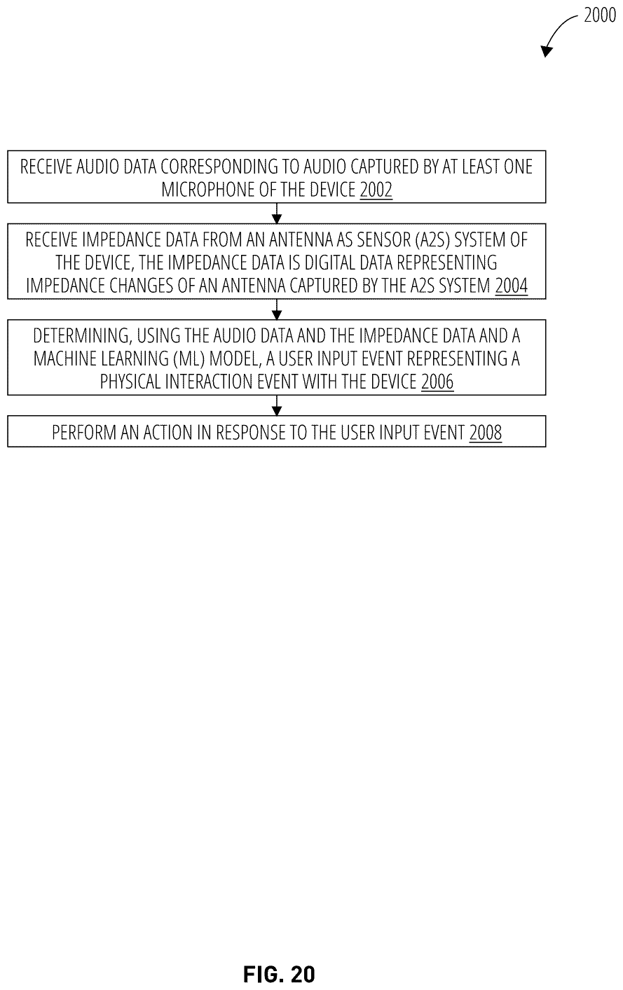

FIG. 20 is a flow chart of a method 2000 of detecting a physical interaction event according to at least one embodiment. The method 2000 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 2000 is performed by the wireless device 100 of FIG. 1. In one embodiment, the method 2000 is performed by the first wireless device 1604, second wireless device 1608, or third wireless device 1612 of FIG. 16. The method 2000 can be performed by other devices described herein.

Referring to FIG. 20, the method 2000 begins with the processing logic receiving audio data corresponding to audio captured by at least one microphone of a wireless device. At block 2004, the processing logic receives impedance data from an Antenna as Sensor (A2S) system of the wireless device, the impedance data is digital data representing impedance changes of an antenna captured by the A2S system. At block 2006, the processing logic determines, using the audio data and the impedance data and a machine learning (ML) model, a user input event representing a physical interaction event with the wireless device. At block 2008, the processing logic performs an action in response to the user input event.

In at least one embodiment, the processing logic preprocesses the impedance data to obtain a first waveform of magnitudes at a first sampling rate. The processing logic preprocesses the audio data to obtain a second waveform of amplitudes at the first sampling rate. The processing logic determines whether the first waveform exceeds a first threshold and the second waveform exceeds a second threshold within a certain time window. The processing logic determines a region of interest (ROI) in the first waveform and the second waveform for inputs to the ML model, responsive to the first waveform exceeding the first threshold and the second waveform exceeding the second threshold within the certain time window.

In at least one embodiment, the processing logic, to preprocess the impedance data, identifies a sequential pattern of pulses and extracting a peak value of each pulse, the sequential pattern of pulses corresponding to a plurality of advertisement packets over the antenna over a plurality of channels during a first time window. The processing logic generates, using the peak values, a multi-channel waveform representing the impedance changes of the antenna in the plurality of channels during the first time window, wherein the multi-channel waveform is the first waveform.

In at least one embodiment, the processing logic, to preprocess the audio data, applies a 30-Hz low-pass digital filter to the audio data and down-samples the audio data from a second sampling rate at the first sampling rate to obtain the second waveform at the first sampling rate. In at least one embodiment, the first sampling rate is 25 Hz.

In at least one embodiment, the processing logic transmits a plurality of advertisement packets over the antenna over a plurality of channels during a first time window. The processing logic measures and converts, using a detection circuit of the A2S system, the impedance changes of the antenna into an analog voltage signal. The processing logic converts the analog voltage signal, by an analog-to-digital converter (ADC) of the A2S, into the impedance data corresponding to the first time window.

In at least one embodiment, the ML model is a convolutional neural network. The processing logic determines the user input event by predicting, using the convolution neural network, whether a segment of the audio data and a corresponding segment of the impedance data corresponds to the user input event representing the physical interaction event with the device.

In at least one embodiment, the user input event is at least one of a tap event, a single-touch event corresponding to a user touch of the device, a multi-touch event corresponding to multiple simultaneous user touches of the device, or a gesture event involving a user touch or user touches of the device.

In at least one embodiment, the method includes generating, using one or more microphones of an electronic device, audio data and transmitting, using an antenna of the electronic device, a first signal. The method further includes generating, based on a second signal from a detection circuit coupled to the antenna, impedance data associated with the transmitting. The method further includes determining, based on the audio data and the impedance data and using a machine learning (ML) model, user input data indicating physical interaction with the device. The method further includes performing an action based on the user input data.

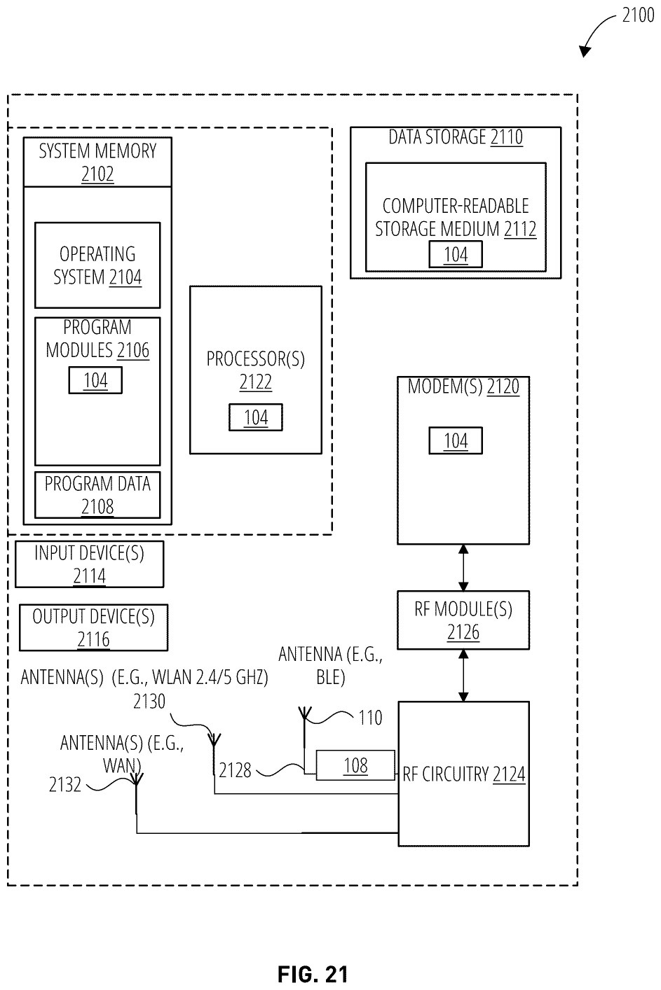

FIG. 21 is a block diagram of a wireless device 2100 with tap classification logic 104 and a detection circuit 108 according to one embodiment. The wireless device 2100 may correspond to any devices described above with respect to FIG. 1 to FIG. 20. In the depicted embodiment, the wireless device 2100 includes the tap classification logic 104 and detection circuit 108. Alternatively, the wireless device 2100 may be other electronic devices, as described herein. In at least one embodiment, the wireless device 2100 may correspond to multiple different designs without departing from the disclosure. For example, the wireless device 2100 can be a first speech-detection device having a first microphone array (e.g., six microphones), a second speech-detection device having a second microphone array (e.g., two microphones), a display device, a tablet computer, a smart watch, a smart phone, or other electronic devices. Each of these devices may apply the tap detection algorithm described above to perform tap detection and detect a physical interaction with the device without departing from the disclosure. Additionally or alternatively, multiple devices may contain components of the system, and the devices may be connected over a network. The network(s) may include a local or private network or may include a wide network such as the Internet. Devices may be connected to the network(s) through either wired or wireless connections without departing from the disclosure. For example, some of the devices may be connected to the network(s) through a wireless service provider, over a WLAN (e.g., Wi-Fi) or cellular network connection, and/or the like, although the disclosure is not limited thereto.

The wireless device 2100 includes one or more processor(s) 2122, such as one or more CPUs, microcontrollers, field-programmable gate arrays, or other types of processors. The wireless device 2100 also includes system memory 2102, which may correspond to any combination of volatile and/or non-volatile storage mechanisms. The system memory 2102 stores information that provides operating system component 2104, various program modules 2106, program data 2108, and/or other components. In one embodiment, the system memory 2102 stores instructions of methods to control the operation of the wireless device 2100. The wireless device 2100 performs functions by using the processor(s) 2122 to execute instructions provided by the system memory 2102. In one embodiment, the program modules 2106 may include the tap classification logic 104 described herein. The tap classification logic 104 may perform some of the operations for detection gestures, touch events, hover events, or the like, as described herein.

The wireless device 2100 also includes a data storage device 2110 that may be composed of one or more types of removable storage and/or one or more types of non-removable storage. The data storage device 2110 includes a computer-readable storage medium 2112 on which is stored one or more sets of instructions embodying any of the methodologies or functions described herein. Instructions for the program modules 2106 (e.g., tap classification logic 104) may reside, completely or at least partially, within the computer-readable storage medium 2112, system memory 2102, and/or within the processor(s) 2122 during execution thereof by the wireless device 2100, the system memory 2102 and the processor(s) 2122 also constituting computer-readable media. The wireless device 2100 may also include one or more input device(s) 2114 (keyboard, mouse device, specialized selection keys, etc.) and one or more 2116 (displays, printers, audio output mechanisms, etc.).

The wireless device 2100 further includes one or more modem(s) 2120 to allow the wireless device 2100 to communicate via wireless connections (e.g., such as provided by the wireless communication system) with other computing devices, such as remote computers, an item providing system, and so forth. The modem(s) 2120 can be connected to one or more radio frequency (RF) modules 2126. The RF modules 2126 may be a WLAN module, a WAN module, a wireless personal area network (WPAN) module, a Global Positioning system (GPS) module, or the like. The antenna 110, and other antenna(s) 2130 and 2132 are coupled to the rf circuitry 2124, which is coupled to the modem(s) 2120. The antenna 110 is coupled to the detection circuit 108. The rf circuitry 2124 may include radio front-end circuitry, antenna switching circuitry, impedance matching circuitry, or the like. The antenna 110 can be a PAN antenna (e.g., BLE). The antenna(s) 2130, 2132 may be GPS antennas, a near field communication (NFC) antennas, other WAN antennas, WLAN or PAN antennas, or the like. The modem(s) 2120 allows the wireless device 2100 to handle both voice and non-voice communications (such as communications for text messages, multimedia messages, media downloads, web browsing, etc.) with a wireless communication system. The modem(s) 2120 may provide network connectivity using any type of mobile network technology including, for example, cellular digital packet data (CDPD), general packet radio service (GPRS), EDGE, universal mobile telecommunications system (UMTS), 1 times radio transmission technology (1×RTT), evaluation data optimized (EVDO), high-speed downlink packet access (HSDPA), Wi-Fi®, Long Term Evolution (LTE) and LTE Advanced (sometimes generally referred to as 4G), etc.

The modem(s) 2120 may generate signals and send these signals to the antenna 110 of a first type (e.g., BLE), antenna(s) 1230 of a second type (e.g., WLAN 2.4 GHz), and/or antenna(s) 1232 of a third type (e.g., WAN), via RF circuitry 2424, and rf module(s) 2126 as described herein. antenna 110 and antenna(s) 2130, 2132 may be configured to transmit in different frequency bands and/or using different wireless communication protocols. The antenna 110, antenna(s) 2130, 2132 may be directional, omnidirectional, or non-directional antennas. In addition to sending data, antenna 110, antenna(s) 2130, 2132 may also receive data, which is sent to appropriate RF modules connected to the antennas. The antenna 110 may be any combination of the antenna structures described herein.

In one embodiment, the wireless device 2100 establishes a first connection using a first wireless communication protocol, and a second connection using a different wireless communication protocol. The first wireless connection and second wireless connection may be active concurrently, for example, if a wireless device is receiving a media item from another wireless device via the first connection) and transferring a file to another electronic device (e.g., via the second connection) at the same time. Alternatively, the two connections may be active concurrently during wireless communications with multiple devices. In one embodiment, the first wireless connection is associated with a first resonant mode of an antenna structure that operates at a first frequency band and the second wireless connection is associated with a second resonant mode of the antenna structure that operates at a second frequency band. In another embodiment, the first wireless connection is associated with a first antenna structure and the second wireless connection is associated with a second antenna. In other embodiments, the first wireless connection may be associated with content distribution within mesh nodes of a wireless mesh network and the second wireless connection may be associated with serving a content file to a client consumption device, as described herein.

In the above description, numerous details are set forth. It will be apparent, however, to one of ordinary skill in the art having the benefit of this disclosure, that embodiments may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMs, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

The concepts disclosed herein may be applied within a number of different devices and computer systems, including, for example, general-purpose computing systems, multimedia set-top boxes, televisions, stereos, radios, server-client computing systems, telephone computing systems, laptop computers, cellular phones, personal digital assistants (PDAs), tablet computers, wearable computing devices (watches, glasses, etc.), other mobile devices, etc.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. Persons having ordinary skill in the field of computers and speech processing should recognize that components and process steps described herein may be interchangeable with other components or steps, or combinations of components or steps, and still achieve the benefits and advantages of the present disclosure. Moreover, it should be apparent to one skilled in the art, that the disclosure may be practiced without some or all of the specific details and steps disclosed herein.

Aspects of the disclosed system may be implemented as a computer method or as an article of manufacture such as a memory device or non-transitory computer readable storage medium. The computer readable storage medium may be readable by a computer and may comprise instructions for causing a computer or other device to perform processes described in the present disclosure. The computer readable storage medium may be implemented by a volatile computer memory, non-volatile computer memory, hard drive, solid-state memory, flash drive, removable disk, and/or other media. In addition, components of system may be implemented in different forms of software, firmware, and/or hardware, such as an acoustic front end (AFE), which comprises, among other things, analog and/or digital filters (e.g., filters configured as firmware to a digital signal processor (DSP)). Further, the teachings of the disclosure may be performed by an application specific integrated circuit (ASIC), field programmable gate array (FPGA), or other component, for example.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements, and/or steps are in any way required for one or more embodiments or that one or more embodiments necessarily include logic for deciding, with or without other input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

As used in this disclosure, the term “a” or “one” may include one or more items unless specifically stated otherwise. Further, the phrase “based on” is intended to mean “based at least in part on” unless specifically stated otherwise.

What is claimed is:

1. A wireless device comprising:
at least one microphone to capture audio data in a first time window;
an antenna to receive radio frequency (RF) signals from the radio and radiate electromagnetic energy to another wireless device in the first time window;
a radio coupled to the antenna;
a processing device coupled to the radio and the at least one microphone, the processing device comprising an analog-to-digital converter (ADC) and tap classification logic; and
a detection circuit coupled between the radio and the antenna, the detection circuit to output an analog voltage signal to the ADC of the processing device to generate an Antenna as Sensor (A2S) signal, the A2S signal representing characteristics of impedance changes of the antenna, wherein:
the tap classification logic is to receive the A2S signal from the ADC and generate a first waveform representing the impedance changes of the antenna during the first time window;
the tap classification logic is to receive the audio data and preprocess the audio data to obtain a second waveform representing audio excitations during the first time window;
the tap classification logic is to determine, using a machine learning (ML) model with inputs comprising the first waveform and the second waveform, a user input event representing a physical interaction event with the wireless device, the physical interaction comprising at least one of a tap, a swipe, or a button press; and
the processing device is to perform an action in response to the user input event.

2. The wireless device of claim 1, wherein:
the radio is to transmit a plurality of advertisement packets over the antenna over a plurality of channels during the first time window;
the detection circuit is to measure and convert the impedance changes of the antenna into the analog voltage signal during the first time window;
the tap classification logic is to identify a sequential pattern of pulses in the A2S signal from the ADC and extract a peak value of each pulse, the sequential pattern of pulses corresponding to the plurality of advertisement packets;
the tap classification logic is to generate, using the peak values, a multi-frequency channels, quasi-continuous waveform representing the impedance changes of the antenna in the plurality of channels during the first time window; and
the multi-channel, quasi-continuous waveform is the first waveform input into the ML model.

3. The wireless device of claim 1, wherein, to preprocess the audio data, the tap classification logic is to:
apply a 30-Hz low-pass digital filter to the audio data; and
down-sample the audio data from a first sampling rate to a second sampling rate to obtain the second waveform, wherein the second sampling rate is equal to a sampling rate of the ADC.

4. A method comprising:
generating, using one or more microphones of an electronic device, audio data;
transmitting, using an antenna of the electronic device, a first signal;
generating, based on a second signal from a detection circuit coupled to the antenna, impedance data associated with the transmitting;
determining, based on the audio data and the impedance data and using a machine learning (ML) model, user input data indicating physical interaction with the device; and
performing an action based on the user input data.

5. The method of claim 4, further comprising:
preprocessing the impedance data to obtain a first waveform of magnitudes at a first sampling rate;
preprocessing the audio data to obtain a second waveform of amplitudes at a second sampling rate;
determining whether the first waveform exceeds a first threshold and the second waveform exceeds a second threshold within a certain time window; and
determining a region of interest (ROI) in the first waveform and the second waveform for inputs to the ML model, responsive to the first waveform exceeding the first threshold and the second waveform exceeding the second threshold within the certain time window.

6. The method of claim 5, wherein the first sampling rate is equal to the second sampling rate, wherein the first sampling rate is approximately 25 Hz.

7. The method of claim 5, wherein preprocessing the impedance data comprises:
identifying a sequential pattern of pulses and extracting a peak value of each pulse, the sequential pattern of pulses corresponding to a plurality of advertisement packets over the antenna over a plurality of channels during a first time window; and
generating, using the peak values, a multi-frequency-channel waveform representing the impedance changes of the antenna in the plurality of channels during the first time window, wherein the multi-channel waveform is the first waveform.

8. The method of claim 5, wherein preprocessing the audio data comprises:
applying a 30-Hz low-pass digital filter to the audio data; and
down-sampling the audio data from a second sampling rate at the first sampling rate to obtain the second waveform at the first sampling rate.

9. The method of claim 4, further comprising:
transmitting a plurality of advertisement packets over the antenna over a plurality of channels during a first time window.

10. The method of claim 4, wherein the second signal is an analog voltage signal, and wherein the generating of the impedance data comprises generating the impedance data based on the second signal using an analog to digital converter of the electronic device.

11. The method of claim 4, wherein the user input data indicates at least one of a tap event, a single-touch event corresponding to a user touch of the device, a multi-touch event corresponding to multiple simultaneous user touches of the device, or a gesture event involving a user touch or user touches of the device.

12. An electronic device comprising:
an antenna;
a detection circuit coupled to the antenna;
a wireless communication component coupled to the antenna;
at least one microphone;
one or more processors; and
one or more computer readable media storing processor executable instructions which, when executed using the one or more processors, cause the electronic device to perform operations comprising:
receiving audio data corresponding to audio captured by the at least one microphone of the electronic device;
receiving impedance data determined based on a signal generated by the detection circuit, the impedance data indicating one or more impedance changes of the antenna; and
determining, based on the audio data and the impedance data and using a machine learning model, user input data indicating physical interaction with the electronic device; and
performing an action based on the user input data.

13. The electronic device of claim 12, wherein the one or more computer readable media store processor executable instructions which, when executed using the one or more processors, cause the electronic device to perform operations comprising:
preprocessing the impedance data to obtain a first waveform of magnitudes at a first sampling rate;
preprocessing the audio data to obtain a second waveform of amplitudes at the first sampling rate;
determining whether the first waveform exceeds a first threshold and the second waveform exceeds a second threshold within a certain time window; and
determining a region of interest (ROI) in the first waveform and the second waveform for inputs to the ML model, responsive to the first waveform exceeding the first threshold and the second waveform exceeding the second threshold within the certain time window.

14. The electronic device of claim 13, wherein the first sampling rate is approximately 25 Hz.

15. The electronic device of claim 13, wherein preprocessing the impedance data comprises:
identifying a sequential pattern of pulses and extracting a peak value of each pulse, the sequential pattern of pulses corresponding to a plurality of advertisement packets over the antenna over a plurality of channels during a first time window; and
generating, using the peak values, a multi-channel waveform representing the impedance changes of the antenna in the plurality of channels during the first time window, wherein the multi-channel waveform is the first waveform.

16. The electronic device of claim 13, wherein preprocessing the audio data comprises:
applying a 30-Hz low-pass digital filter to the audio data; and
down-sampling the audio data from a second sampling rate to the first sampling rate to obtain the second waveform at the first sampling rate.

17. The electronic device of claim 12, wherein the one or more computer readable media store processor executable instructions which, when executed using the one or more processors, cause the electronic device to perform operations comprising:
transmitting a plurality of advertisement packets over the antenna over a plurality of channels during a first time window;
measuring and converting, by a detection circuit of the A2S system, the impedance changes of the antenna into an analog voltage signal; and
converting the analog voltage signal, by an analog-to-digital converter (ADC) of the A2S, into the impedance data corresponding to the first time window.

18. The electronic device of claim 12, wherein the ML model is a neural network, wherein determining the user input event comprises predicting, using the neural network, whether a segment of the audio data and a corresponding segment of the impedance data corresponds to the user input event representing the physical interaction event with the electronic device.

19. The electronic device of claim 12, further comprising an analog-to-digital converter (ADC), the ADC to receive an analog voltage signal from the detection circuit and sample the analog voltage signal at a first sampling rate to generate the impedance data.

20. The electronic device of claim 12, wherein the user input data indicates at least one of a tap event, a single-touch event corresponding to a user touch of the electronic device, a multi-touch event corresponding to multiple simultaneous user touches of the electronic device, a swipe event involving a user touch or user touches of the electronic device, or a gesture event involving a user touch or user touches of the electronic device.
